(19) United States
(12) Patent Application Publication
(10) Pub. No.: US 2022/0152612 A1
(43) Pub. Date: May 19, 2022

(54) A MICROPARTICLE AND/OR NANOPARTICLE SEPARATION, FILTRATION AND/OR ENRICHING DEVICE AND METHOD

(71) Applicant: Monash University, Clayton (AU)

(72) Inventors: Ruhollah HABIBI, Clayton (AU); Adrian NEILD, Clayton (AU)

(21) Appl. No.: 17/598,380

(22) PCT Filed: Mar. 27, 2020
(86) PCT No.: PCT/AU2020/050300

§ 371 Date: Sep. 27, 2021

(30) Foreign Application Priority Data
Mar. 27, 2019 (AU) 2019901035

(51) Int. Cl. B01L 3/00; B01D 24/30; B01D 24/48

(52) U.S. Cl. CPC B01L 3/502761; B01L 3/502715; B01L 3/50273; B01D 24/305; B01D 24/48; B01D 2101/00; B01L 2400/0436; B01L 2300/0645; B01L 2300/0681; B01L 2300/0816; B01L 2400/0439; B01L 2200/0652

(57) ABSTRACT

A microparticle and/or nanoparticle separation, filtration and/or enriching device. The device comprises a flow passage through which can be directed a liquid suspension supporting microparticles and/or nanoparticles therein, and at least one packed bed of particles physically retained within the flow passage through which can pass therethrough the liquid suspension. The device further comprises an ultrasonic actuation system for mechanically activating the or each packed bed during passage therethrough of the liquid suspension.

### TECHNICAL FIELD

The present invention is generally directed to separation, filtration and/or enriching systems, and in particular to a separation, filtration and/or enriching device and method for microparticles and nanoparticles.

### BACKGROUND

Separation, enrichment and delivery of microparticles and nanoparticles constitute a crucial part in the process of handling and investigating of submicron scale chemical, biological and biomedical matter. They have been used in viral or nanoparticle fusion of cells, detection and diagnostics, the synthesis of nanoparticles, nanomedicine, nanoscale drug delivery and nanowires. Also in biological analysis of lysed cell components, DNA, viruses and bacteria collection of scarce nanoparticles through different processes of concentration enrichment, separation or isolation, filtration and purification has significant importance. In the field of biological and biomedical studies there has been a recent surge in interest in capturing of extracellular vesicles (EVs). These are formed inside cells, secreted through the cell membrane and can contain genetic information of the parent cell. They are believed to be responsible for cell-cell communication, antigen-presenting cell, coagulation and transfer of proteins so considered as a potential biomarker and a valuable precursor for regenerative medicines.

EVs refers to a broad range of vesicles including microvesicles (MVs), apoptotic bodies and exosomes. They have a variety of sizes ranging from about 30 to 1000 nm. To use them as biomarkers they need to be separated and segregated into their particular type. Similarly, for drug synthesis a need for a very quick and clean method of collection and enrichment has been identified. Conventional methods for EV collection include ultra-centrifugation, ultra-filtration, immunocapture, chromatography and precipitation. Of these, the first two are more widely used but are time consuming, laborious and generally damaging to the bioparticles, whilst the latter examples are only applicable to small sample volumes and the chemical bonds formed can cause contamination of the captured matter. As an alternative, emerging microfluidic-based methods show significant promise.

Whilst microfluidics has widely been used for the separation, trapping and enrichment of microparticles, there is also a growing body of literature on nanoparticle handling. To achieve this several mechanisms have been exploited, including passive hydrodynamic methods such as micropillars, filtration, inertial-based techniques. In addition to these passive methods, a range of active systems have been developed. Here energy is inputted into the system to activate a collection mechanism, thereby allowing a level of control and adaption of system parameters post manufacture, which is unavailable in passive architectures. Various forcing mechanisms have been utilised, including electro and dielectrophoresis, magentophoresis, acoustophoresis and optical tweezers. Of these active methods, acoustofluidics has the advantage of being contactless, label-free and biocompatible.

Acoustofluidics, the use of acoustic energy as an actuation source in microfluidic chips, offers three main forcing mechanisms. Acoustic radiation forces (ARF) act on suspended particles causing migration to certain, ultrasonic field dependant, locations in the fluid volume. ARF is frequently used to control the position of microparticles and cells. However, there are only a few examples of usage on nanoparticles. This is due to scaling laws, meaning as the particle becomes smaller acoustic streaming induced drag forces become more dominant. Acoustic streaming a bulk fluid flow that results from the propagation of ultrasound, typically induces swirling flows which disrupt the patterns formed by ARF. However, these flows can also be used to capture cells and nanoparticles where the suspended matter becomes trapped within a vortex within the limitation of a low capacity limit and flow rate. The third focusing method arises due to particle-particle interaction. The ultrasonic wave scattered from one particle interacts with other nearby objects, and induces a Bjerknes force, which depending on the nature of the particles and their orientation can be attractive or repulsive. In a very elegant approach, Hammarström et al. held a cluster of microparticles using the ARF generated by a sound field, the scattered waves engendered Bjerknes forces to act on nanoparticles as they passed near this cluster, such that they were collected on the microparticles. (See: Hammarström, B.; Laurell, T.: Nilsson, J. Seed particle-enabled acoustic trapping of bacteria and nanoparticles in continuous flow systems. Lab Chip 2012, 12, 4296-4304). One of the challenges in acoutofluidics is to create a sufficiently large force, and a resonance is usually exploited to tackle this. Bulk wave excitation was therefore used to create a resonance in a fluid channel, so that the microparticles could be held at the centre of the channel, with the Bjerknes forces being sufficient to allow for highly efficient capture. While this system works very well for small, diagnostically relevant, sample sizes, upscaling of this approach beyond this scale would be challenging due to the requirement of a channel resonance. This limits the commercial application of this approach.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

It is an object of the present invention to provide a microparticle and/or nanoparticle separation, filtration and/or enriching device and method that addresses one or more of the disadvantages associated with earlier known systems.

### SUMMARY

Some embodiments relate to a microparticle and/or nanoparticle separation, filtration and/or enriching device comprising:

a flow passage through which can be directed a liquid suspension supporting microparticle and/or nanoparticles therein;

at least one packed bed of particles physically retained within the flow passage through which can pass therethrough the liquid suspension, and an ultrasonic actuation system for mechanically activating the or each packed bed during passage therethrough of the liquid suspension.

The or each packed bed may be formed from at least substantially uniformly sized, shaped particles having the same physical properties. The particles may be generally spherical in shape. It is however also envisaged that the particles have an alternative shape including, but not limited to, ellipsoids, cylinders, pillars/rods and fibres (such as paper fibres, arbitrary shaped pillars and particles).

Each particle may be formed of a polymeric material including, but not limited to, polystyrene, PMMA, nylon, PDMS, OrmoComp. It is however also envisaged that the particles could be made from other materials including, but not limited to a metal, ceramic or crystal material.

The particles may also vary in dimensions from particles having a dimension measured in micrometres, to particles having dimensions measured in millimetres.

A plurality of packed beds may be provided, with each packed bed formed from particles of different shapes, dimensions and/or material properties.

The or each packed bed may be mechanically actuated at or near a resonance frequency of the particles forming the packed bed. A plurality of said packed beds may be provided, each packed bed being mechanically actuated at a different resonance frequency, and/or a different power level.

The particles may have a number of different resonance frequencies which will vary depending on the shape, dimensions and material properties of the particles. For example, in the case of particles having a dimension (d), and the resonance frequency having a wavelength (λ), the first resonance frequency may be approximately above d/λ≥0.25 (for spherical particles) and above d/λ≥0.20 (for cylindrical particles).

In the case of spherical particles made from PS, the or each packed bed may be mechanically actuated at a frequency having a wavelength (λ), and said microparticles of the or at least one of said packed beds have a diameter (d) in the range of around less than 0.3λ to 0.67λ. Preferably, the or each said packed bed may be mechanically actuated at a frequency having a wavelength (λ), and said particles of the or at least one said packed bed have a diameter (d) of less than around 0.31λ. Alternatively, the or each packed bed may be mechanically actuated at a frequency having a wavelength (l), and said particles of the or at least one said packed bed have a diameter (d) in the range of around 0.31λ to 0.45 Alternatively, the or each packed bed may be mechanically actuated at a frequency having a wavelength (l λ), and said particles of the or at least one said packed bed have a diameter (d) in the range of around 0.45λ to 0.67λ.

In the case of particles made from PMMA, the or each packed bed may be mechanically actuated at a frequency having a wavelength (λ), and said particles of the or at least one of said packed beds have a diameter (d) in the range of around less than 0.32λ to less than 0.61λ. Preferably, the or each said packed bed may be mechanically actuated at a frequency having a wavelength (λ), and said particles of the or at least one said packed bed have a diameter (d) of less than around 0.32λ. Alternatively, the or each packed bed may be mechanically actuated at a frequency having a wavelength (λ), and said particles of the or at least one said packed bed have a diameter (d) in the range of around 0.32λ to 0.415λ. Alternatively, the or each packed bed may be mechanically actuated at a frequency having a wavelength (λ), and said particles of the or at least one said packed bed have a diameter (d) in the range of around 0.415λ to 0.61λ.

The microparticle and/or nanoparticle separation, filtration and/or enriching device may further comprise a packed bed retaining system for retaining the packed bed in position within the flow passage, while allowing the passage of microparticles and/or nanoparticles therethrough. In one possible embodiment, the flow passage of the microparticle and/or nanoparticle separation, filtration and/or enriching device may a microfluidic channel. The bed retaining system may comprise one or more micropillar posts extending along the flow passage downstream of the packed bed.

The ultrasonic actuation device may be a piezoelectric device. According to one preferred embodiment, the piezoelectric device may be a surface acoustic wave (SAW) actuator. The use of alternative arrangements for generally the mechanical actuation, such as bulk waves within a piezoelectric device is also envisaged.

Some embodiments relate to a method of separating, filtering and/or enriching microparticles and/or nanoparticles from a liquid suspension comprising:

directing the liquid suspension through a flow passage within which is provided one or more packed beds of physically retained particles through which passes the liquid suspension; and mechanically activating the or each packed bed while the liquid suspension passes through to thereby capture microparticles and/or nanoparticles within the or each packed bed.

The method may comprise mechanically actuating the or each packed bed at or near a resonance frequency of the particles forming the or each said packed bed. Alternatively, the method may comprise mechanically actuating a plurality of said packed beds, each packed bed being mechanically actuated at a different resonance frequency, and/or a different power level.

In the case of particles having a dimension (d), and the resonance frequency having a wavelength (λ), the first resonance frequency may be approximately above d/λ≥0.25 (for spherical particles) and d/λ≥0.20 (for cylindrical particles).

In the case of spherical particles formed from PS, the method may comprise mechanically actuating the or said packed bed at a frequency having a wavelength (λ), said particles of the or at least one of said packed beds having a diameter (d) in the range of around less than 0.3λ to 0.67λ.

The method preferably comprises mechanically actuating the or each said packed bed at a frequency having a wavelength (λ), said particles of the or at least one said packed bed having a diameter (d) of less than around 0.3λ. Alternatively, the method may comprise mechanically actuating the or each packed bed at a frequency having a wavelength (λ), said particles of the or at least one said packed bed having a diameter (d) in the range of around 0.3λ to 0.45λ. Alternatively, the method may comprise mechanically actuating the or each said packed bed at a frequency having a wavelength (λ), said particles having a diameter (d) in the range of around 0.45λ to 0.67λ.

In the case of spherical particles formed from PMMA, the method may comprise mechanically actuating the or said packed bed at a frequency having a wavelength (λ), said particles of the or at least one of said packed beds having a diameter (d) in the range of around less than 0.32λ to 0.61λ.

The method preferably comprises mechanically actuating the or each said packed bed at a frequency having a wavelength (k), said particles of the or at least one said packed bed having a diameter (d) of less than around 0.32λ. Alternatively, the method may comprise mechanically actuating the or each packed bed at a frequency having a wavelength (λ), said particles of the or at least one said packed bed having a diameter (d) in the range of around 0.32λ to 0.415λ. Alternatively, the method may comprise mechanically actuating the or each said packed bed at a frequency having a wavelength (l), said particles having a diameter (d) in the range of around 0.415λ to 0.61λ.

The method may comprise intermittently suspending the mechanical activation of the or each packed bed to thereby release the captured microparticles and/or nanoparticles therefrom.

The method may further comprise delivering batch volume of the liquid suspension through the flow passage. Alternatively, the method may comprise delivering a continuous stream of the liquid suspension through the passage.

The particles being separated may be extracellular vesicles. The extracellular vesicles may include apoptotic bodies and exosomes.

Alternatively, the liquid suspension may be a contaminated water, and the particles may be contaminants within the water. The contaminants may include viruses and bacteria.

Alternatively, the microparticles and/or nanoparticles being separated may be precious metal nanoparticles or DNA.

Some embodiments relate to a system for separating, filtering and/or enriching microparticles and/or nanoparticles from a liquid suspension, the system comprising: one or more processors; memory comprising computer executable code, which when executed by the one or more processors, is configured to perform a filtration process and a subsequent collection process, wherein during the filtration process, the one or more processors are configured to: activate a first switch, wherein the first switch is configured to control fluid flow along a first conduit, the first conduit arranged to provide fluid communication between an outlet of a microparticle and/or nanoparticle separation, filtration and/or enriching device and a first receptacle, and whereby activating the first switch allows fluid flow between the outlet and the first receptacle; and trigger an ultrasound signal to cause an ultrasonic transducer of the device to generate a sound wave to activate a packed bed of particles of the device, to thereby cause microparticles and/or nanoparticles of a liquid suspension to be trapped and collected inside the device and for filtered liquid to be conveyed along the first conduit to the receptacle; and wherein during the collection process, the one or more processors are configured to: turn off the ultrasound signal to stop activation of the packed bed of particles of the device; and deactivate the first switch to impede fluid flow between the outlet and the first receptacle; and activate a second switch, wherein the second switch is configured to control fluid flow along a second conduit, the second conduit arranged to provide fluid communication between the outlet of the device and a second receptacle, and whereby activating the second switch allows fluid flow between the outlet and the second receptacle.

In some embodiments, at the end of a collection process, the one or more processors are configured to execute computer code to cause the system to perform a subsequent filtration process and a subsequent collection process.

In some embodiments, the microparticle and/or nanoparticle separation, filtration and/or enriching device comprises the microparticle and/or nanoparticle separation, filtration and/or enriching device of any of the described embodiments.

Some embodiments relate to a method for separating, filtering and/or enriching microparticles and/or nanoparticles from a liquid suspension, the method comprising: a filtration process and a subsequent collection process, wherein the filtration process comprises: activating a first switch, wherein the first switch is configured to control fluid flow along a first conduit, the first conduit arranged to provide fluid communication between an outlet of a microparticle and/or nanoparticle separation, filtration and/or enriching device and a first receptacle, and whereby activating the first switch allows fluid flow between the outlet and the first receptacle; and triggering an ultrasound signal to cause an ultrasonic transducer of the device to generate a sound wave to activate a packed bed of particles of the device, to thereby cause microparticles and/or nanoparticles of a liquid suspension to be trapped and collected inside the device and for filtered liquid to be conveyed along the first conduit to the receptacle; and wherein the collection process comprises: turning off the ultrasound signal to stop activation of the packed bed of particles of the device; and deactivating the first switch to impede fluid flow between the outlet and the first receptacle; and activating a second switch, wherein the second switch is configured to control fluid flow along a second conduit, the second conduit arranged to provide fluid communication between the outlet of the device and a second receptacle, and whereby activating the second switch allows fluid flow between the outlet and the second receptacle.

In some embodiments, the method comprises performing a subsequent cycle of a filtration process and a subsequent collection process.

Some embodiments relate to a non-transitory machine-readable medium storing instructions which, when executed by one or more processors, cause a system to implement a method according to any of the described methods.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

It will be convenient to further describe the invention with respect to the accompanying drawings, which illustrate embodiments of the microparticle and/or nanoparticle separation, filtration and/or enriching device according to the present invention. Other embodiments are possible, and consequently, the particularity of the accompanying drawings is not to be understood as superseding the generality of the preceding description of the invention.

In the drawings:

FIG. 1 is a schematic view of a microparticle and/or nanoparticle separation, filtration and/or enriching device according to some embodiments;

FIG. 2A to D respectively show numerical results of acoustic radiation force on micro- and nanoparticles;

FIG. 3 is a series of images showing the collection and release of nanoparticles using the microparticle and/or nanoparticle separation, filtration and/or enriching device according to some embodiments;

FIG. 4 respectively shows a) the stepped rectangular pulse, and b) the average intensity level of the upstream side of the wide channel during the frequency sweep applied in the experiments;

FIG. 5 shows the normalised intensity gain for SAW frequency for 3 different power levels applied in the experiments, with the inset image shows the absolute intensity gain of each frequency for different power levels before normalising;

FIG. 6 shows the downstream results of the normalized intensity gain for different power levels applied in the experiments;

FIGS. 7A and B respectively shows a) the instantaneous mean intensity level at downstream side of the channel with the stepped pulse power sweep, and b) normalized intensity gains of different frequencies shows linear compliance with power level, thus a logarithmic leaning against power levels;

FIG. 8A to D respectively shows a) the capturing efficiency at selected frequencies at fixed power level, b) maximum intensity level (capturing) at different flowrates, and c) and d) packed bed area without and with fluorescence filter while with flurorescent filter at (d) the effective trapping area under influence of SAW is obvious;

FIG. 9A to D respectively show the upstream and downstream views, respectively, of trapping polystyrene particles, where captions demonstrate (1) before SAW activation, (2) during SAW activation, (3) instantly upon turning off the SAW and (4) seconds after activation ends;

FIG. 10i to v respectively show schematic illustrations of the system that shows the sequence of the loading of microparticles (MPs) and then nanoparticles (NPs);

FIG. 11 is a graph showing the instantaneous intensity level at the upstream of the channel without activating the SAW, with the insert is a graph showing SAW activated at two different frequencies;

FIG. 12 is a Table providing a summary of theoretical or numerically defined frequency regions according to described embodiments;

FIGS. 13A, 13B and 13C are schematics of a filtration/separation system comprising the device of FIG. 1, wherein the device is in an off state, an activated (filtration) state and a deactivated (separation) state, respectively;

FIG. 14 is an isometric view showing a part of the system of FIG. 13A;

FIG. 15 is an exploded view of the device of the system of FIG. 14;

FIG. 16 illustrates a model of two solid spheres in an axisymmetric 2-dimensional geometry and showing scenarios where the pair can undergo standing wave (SW), assisting positive direction travelling wave (TW+) or negative-direction travelling wave (TW−);

FIGS. 17A, 17B and 17C show graphical representations of simulation results showing attraction force on a 500 nm polystyrene nanoparticle induced by a microparticle positioned at a gap that is adjusted for the size of the pore size where the NP passes through;

FIG. 18 depicts experimental results of nanoparticle collection using the packed bed of 10-micron polystyrene with a range of frequencies from 50 to 100 MHz, which show peaks arising from traveling wave (at about 63 and 85 MHz), and peaks arising from standing wave components of the overall acoustic field;

FIG. 19 shows a comparison of the force generated at all peak frequencies for different sizes (a) and different materials (b);

FIG. 20 shows experimental results of comparing the capturing efficiency of different sizes of beads (in the packed bed).

FIG. 21 shows a comparison of the performance of different materials PS (polystyrene), PMMA (poly((methyl methacrylate)) and SG (silica glass) (all with 10 microbeads) in terms of capturing efficiency;

FIG. 22 is a transmission electron microscopy (TEM) image of the control samples (liposomes before exposure to the ultrasound); and

FIG. 23 is a transmission electron microscopy (TEM) image of a test sample (collected after the continuous exposure to ultrasound and passed through the acoustically activated packed bed)

FIG. 24 illustrates four images of the flow passage including the packed bed and posts at to (before excitation of surface acoustic wave (SAW)), and then at subsequent times after the SAW turned off (t₁=2 seconds after SAW was OFF, t₂=t₁+0.2 sec and t₃=t₁+3 sec).

### DESCRIPTION OF EMBODIMENTS

The term ‘nanoparticles’(NP), when used in the present document refers to particles having a dimension measured in nanometres, and in some embodiments, particles having a diameter between about 1 nm and 500 nm, for example greater than about 1 nm; while the term ‘microparticles’(MP), when used in the present document refers to particles having a dimension measured in micrometres or millimetres, and in some embodiments, particles having a diameter between about 0.1 μm and 100 μm, for example greater than about 100 nm.

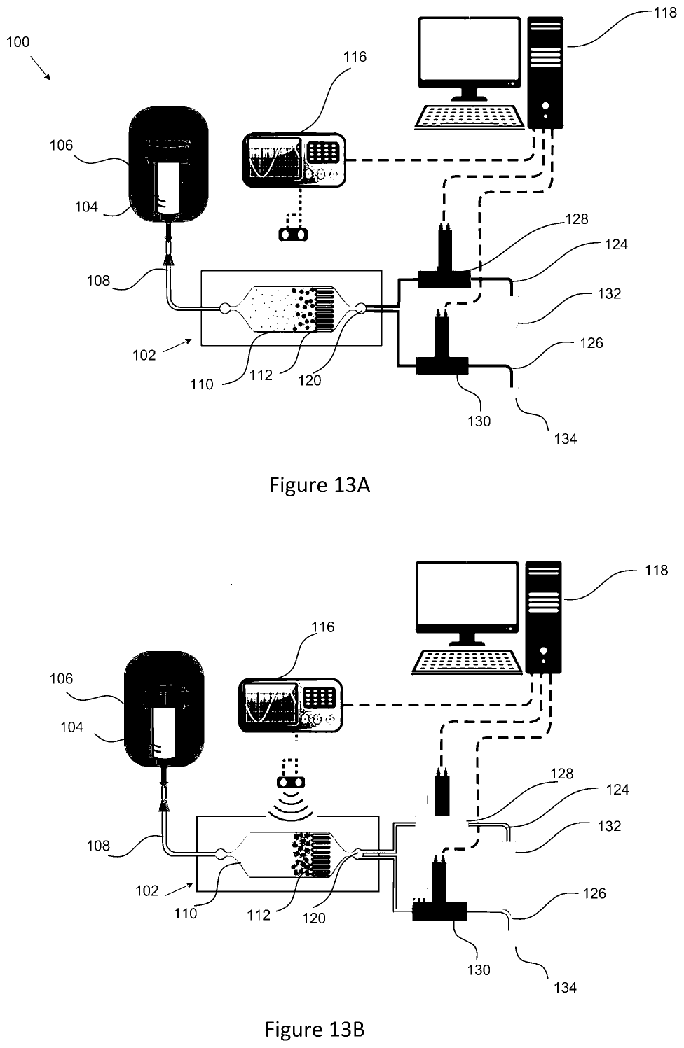

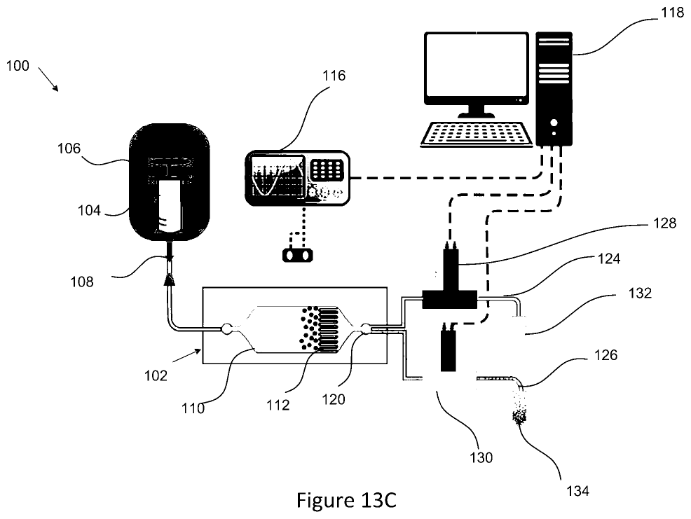

The proof of concept of the described embodiments was demonstrated in a microfluidic system using microfluidic channels and microparticles and as is subsequently described. It is however envisaged that the described embodiments be used in packed bed systems of more conventional size as discussed with reference to FIGS. 13 to 15 below, and accordingly, the described embodiments are therefore not restricted to use in microfluidic systems.

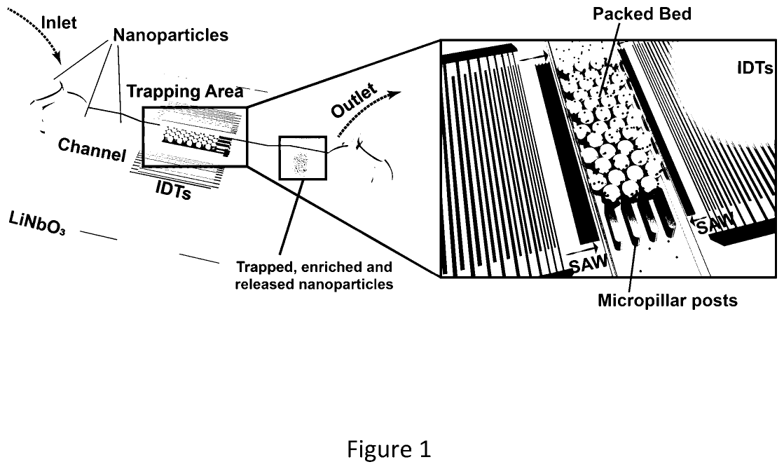

Referring initially to FIG. 1, there is shown a schematic of a microfluidic device for trapping and enriching microparticles and/or nanoparticles according to the described embodiments. In some embodiments, and for example in some of the experiments conducted by the inventors, the microfluidic device comprises a LiNbO₃ substrate surface 3 upon which is provided a microfluidic channel 5. Located within the microfluidic channel 5 is a packed bed 7 formed from microparticles 9. The packed bed 7 is held in position within the channel 5 by a series of micropillar posts 11 extending along the channel 5 downstream of the packed bed 7. A pair of interdigital transducers (IDT) 15,17 are provided on the substrate surface 3, and on opposing sides of the packed bed 7. Application of an electrical signal to the IDTs 15,17 induces a surface acoustic wave (SAW) 19 that mechanically actuates the packed bed 7. The channel 5 has an inlet 4 through which a liquid suspension of nanoparticles 6 can be supplied. The nanoparticles 6 can be trapped in the trapping area 8 within which is located the packed bed 7, and the trapped, enriched nanoparticles 6 can be released to an outlet 10 of the channel 5. The described embodiments use resonance of the passively-trapped packed bed of microparticles 9 (10 μm polystyrene beads were used in the experiments) excited by SAW. The trapping area 8 is shown enlarged to show the two opposing IDTs 15,17 that generate a standing SAW 19, and the micropillar posts 11 that retain in position the microparticles 9. Upon switching off of the SAW, a batch of the trapped and enriched nanoparticles 12 is released into the channel 5 downstream.

Packed beds of beads have been widely used for filtration or chemical process reactors. In addition, in microfluidics, functionalised beads in a packed bed have occasionally been used to trap certain type of proteins or bioparticles. According to the described embodiments, rather than using chemical functionalisation, the use of mechanical (ultrasonic) actuation is proposed. Surface acoustic waves (SAW) is an actuation method which gives access to a higher range of frequencies than typically excited using bulk acoustic waves. They have been used in microfluidics for patterning, sorting, sieving and trapping. Here, however, rather than trapping the microparticles, they are used to resonate them whilst they are trapped (in a packed bed) by a physical barrier.

Notably, high frequency operation has been used for single cell patterning in which the acoustic wavelength in the order of the size of a cell. When modelling the ARF and Bjerknes forces generated in this type of system, the inventors previously showed a very large increase in the Bjerknes force at resonance frequencies of the particles which we were trying to manipulate, such that clustering dominated over patterning (see Habibi, R.; Devendran, C.; Neild, A. Trapping and patterning of large particles and cells in a 1D ultrasonic standing wave. Lab Chip 2017, 17, 3279-3290). Hence, here, the high frequency opportunities offered by SAW is used to deliberately excite a packed bed of microparticles, such that each resonates. When nanoparticles are passed through the pores left between the larger particles, they get attracted and collected due to the large Bjerknes forces which occur. As such, the resonance is related to the particle size, and so is decoupled from the channel dimensions (FIG. 1).

### Results and Discussion

### Operating Principles

Without wishing to be bound by theory, the inventors provide the description on the operating principles of the described embodiments.

In most acoustically actuated microfluidic systems, the particulate manner is highly dilute and the wavelength of sound is far in excess of the particle size. In this way, phenomena such as particle migration to the pressure nodes of a standing sound wave can be observed, and used for tasks such as particle sorting and manipulation. Recently, there have been some studies which utilise higher frequencies of operation, such that the wavelength is decreased and approaches the size of the particles. But, here too, the sample is dilute as patterning effects were being sought (see: Collins, D. J.; Morahan, B.; Garcia-Bustos, J.; Doerig, C.; Plebanski, M.; Neild, A. Two-dimensional single-cell patterning with one cell per well driven by surface acoustic waves. Nature Communications 2015, 6, 8686). In contrast, the described embodiments use a packed bed, in which movement of the microparticles is undesirable, and seek to resonate the particles to have maximum interparticle effects. To examine if this is possible, the inventors first examined numerically if the interparticle forces between the microparticles are such that the packed bed will remain intact upon excitation, and secondly to show the relationship between frequency and the forces being exerted on nanoparticles as they pass near a vibrating microparticle.

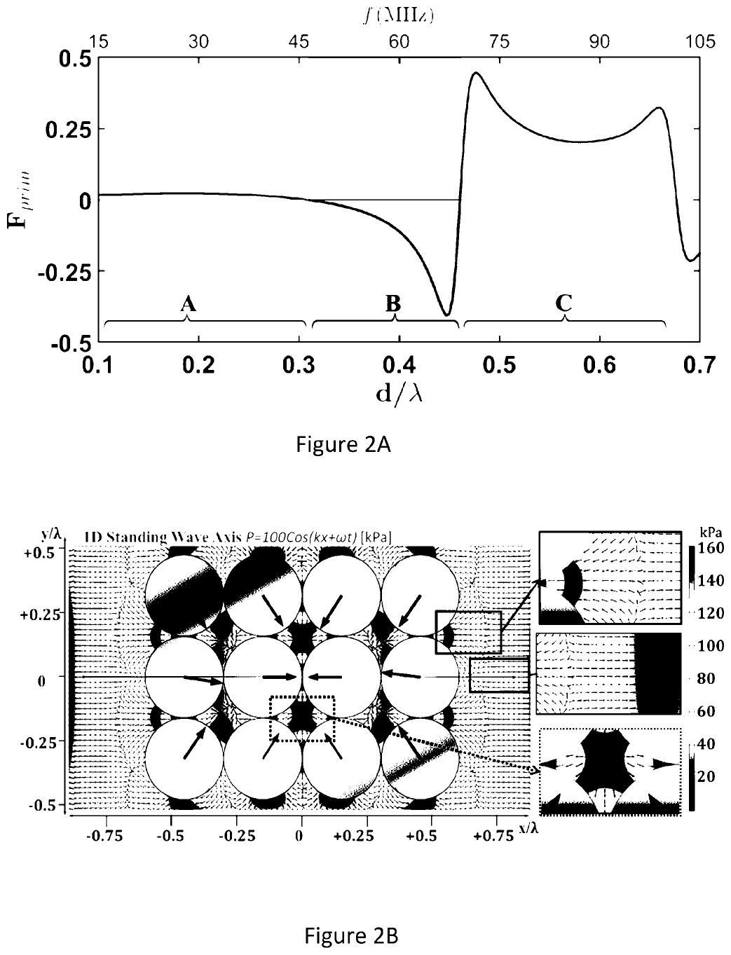

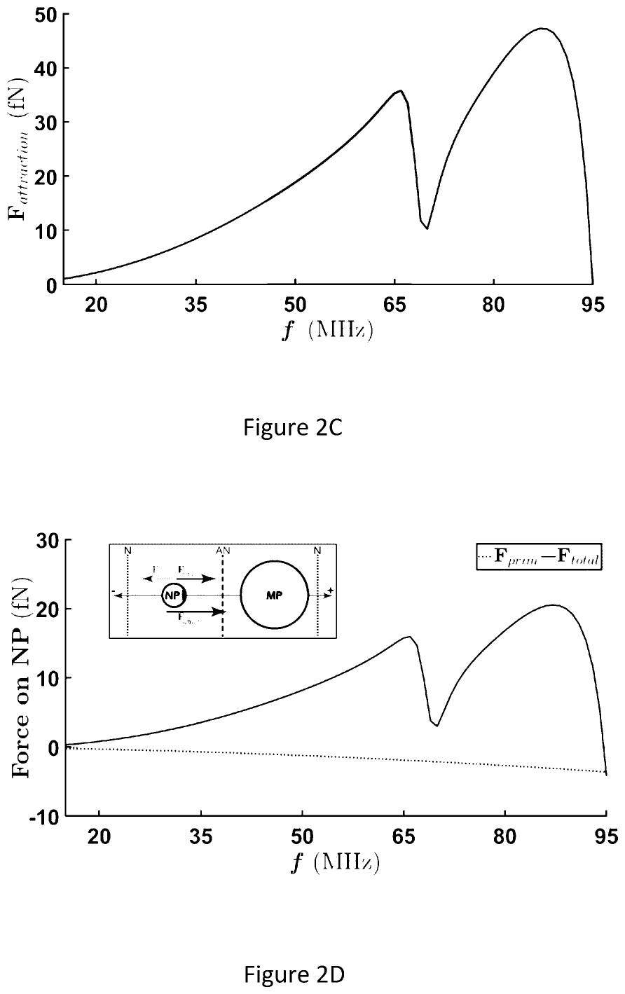

FIG. 2 respectively show numerical results of acoustic radiation force on micro- and nanoparticles (a) Primary acoustic radiation force on single polystyrene (PS) particle located at +λ/8 that shows distinct A, B and C regions. Frequency range is for a 10 μm PS in water under a 1D sound wave with 100 kPa amplitude. There is one resonance frequency at region B and two at region C. (b) A small cluster of microparticles (MPs) that are in their region B shows that interparticle forces bring cluster together and force field leads the nanoparticles (NPs) enclosed between MPs toward their neighbour MP while NPs far from the cluster are pushed the pressure nodes. All forces are normalised to only show the direction and not proportional to their magnitude. The frequency regions with respect to the microparticle have an apparent effect on the attraction force that is applied on the nanoparticle. Here, results are shown for a 10 μm and a 500 nm PS particles within a normalised gap of λ/100 about a pressure antinode in a 1D standing sound wave with 100 kPa amplitude. The total acoustic radiation force on the NP attracts it to the MP and the main contributor is the secondary force (attraction force) while the primary force is significantly smaller and in opposite direction.

Previously, the inventors examined forces between microparticles as a function of frequency, for the purpose of finding operating conditions at which the particles will be held separated from each other in a sound field (Habibi, R.; Devendran, C.; Neild, A. Trapping and patterning of large particles and cells in a 1D ultrasonic standing wave. Lab Chip 2017, 17, 3279-3290). Such repulsive interparticle effects could be highly detrimental to a packed bed. However this earlier study provides the framework required to establish at what frequencies a packed bed can be expected to be stable. Namely, in that work, frequency regions were defined based on the forces which are known to act on a single particle exposed to a standing pressure wave when located in the middle of a pressure node and antinode, as shown in FIG. 2a. It can be seen that for the polystyrene (PS) particle considered, if the particle size is smaller than one third of the wavelength the acoustic radiation force is positive, meaning it will migrate to the pressure nodes (region A: d<0.31λ) where d is the diameter of the spherical particle and k is the wavelength of a 1D standing planar wave. At larger particle sizes the acoustic radiation force is negative, hence the particle is moved to the nearest antinode (Region B: 0.31λ<d<0.45λ). The first particle resonance occurs in this region of operation, as seen by the spike in force magnitude. This alternation of the sign of the force is also used to define further regions (e.g. Region C: 0.45λ<d<0.67λ). The boundaries between these ranges are dependent to the material properties of the spherical elastic particle, which can be difficult to determine exactly. It was shown that interparticle forces between two particles separated by small gaps (in the order of λ/100) about a pressure antinode are attractive in regions A, B and C except for a narrow band in region C. Based on this, the inventors expect the packed bed to be stable under most conditions. To confirm this and to investigate the force field acting around large particles, the inventors modelled a small cluster in which the particles (having their normalised sizes within the range of region B) which are placed adjacent to each other, as would occur in a packed bed, and showed that the interparticle forces are attractive, FIG. 2b.

In PMMA microparticles, the ranges were determined as follows: region A d<0.32λ; region B 0.32λ<d<0.415λ; region C 0.415λ<d<0.61λ.

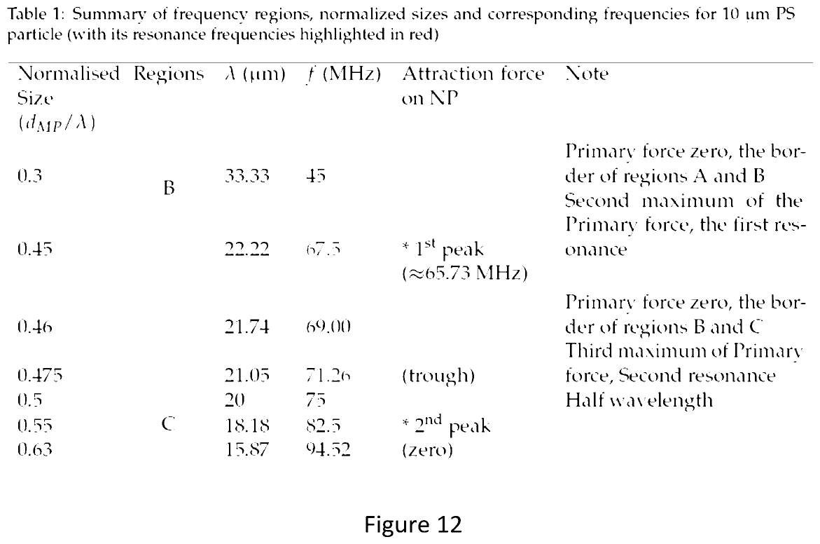

The inventors examined the attraction force which exists between a vibrating microparticle and a nearby nanoparticle. Again, the inventors examined this with reference to the regions of operation (taking into account the size of the microparticle). For a pair of 10 μm and 500 nm polystyrene spherical particles with a fixed gap of λ/100 (at each frequency), the total force on the NP is shown in FIG. 2d. In addition, the primary force acting on the nanoparticle in the opposite direction (negative sign) was also shown for comparison. This data showed that the secondary force contributed the main part of the total acoustic force on the NP. Furthermore, FIG. 2c shows it increases dramatically in region B (similar to PMMA), becoming a maximum at the first resonance frequency. At higher frequencies a drop in force amplitude is observed at the second microparticle resonance (very close to the border between Regions B and C where the primary force is zero), after a further peak before it drops to a low level at a frequency equivalent to d_{MP}/λ≈0.63 (still in region C). Conversely, highest attraction on NPs takes place at resonance frequency in region B and marginally after resonance frequency in Region C. The summary of important frequencies in a system of 10 μm and 500 nm PS particles is given in Table 1, as shown in FIG. 12.

The Bjerknes force is inversely related to the distance between two particles, so whilst just a single separation is shown in FIG. 2d, the trend is more broadly applicable. In the described embodiments, using a packed bed, the maximum separation distance is constrained by the size of the “pores” between the microparticles.

This theoretical study, whilst not fully modelling a mechanically actuated packed bed, shows the key underlying physics behind the operation, specifically with relation to the role of microparticle particle resonance. The inventors made use of the interparticle forces between microparticles to maintain a stable packed bed, and then chose the operating frequency based on the occurrence of a maximum force between the micro- and nanoparticles. This corresponds to conditions detailed in Table 1.

### Collection Measurement

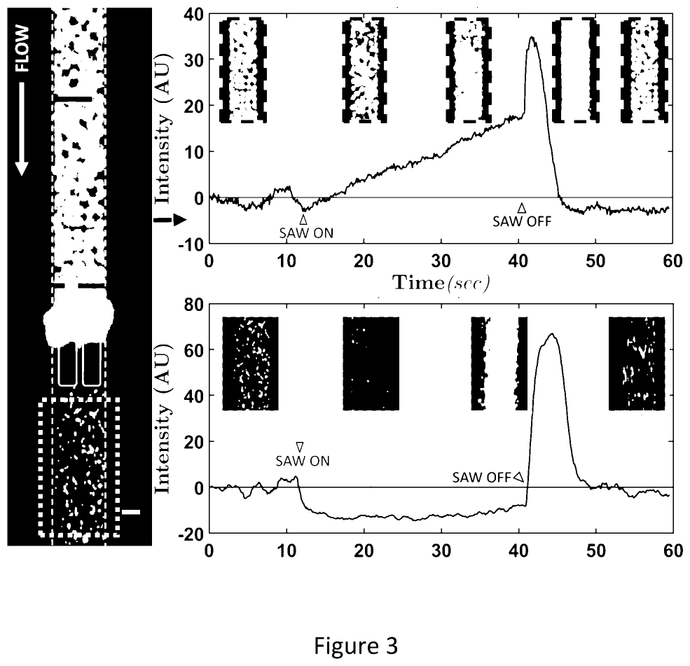

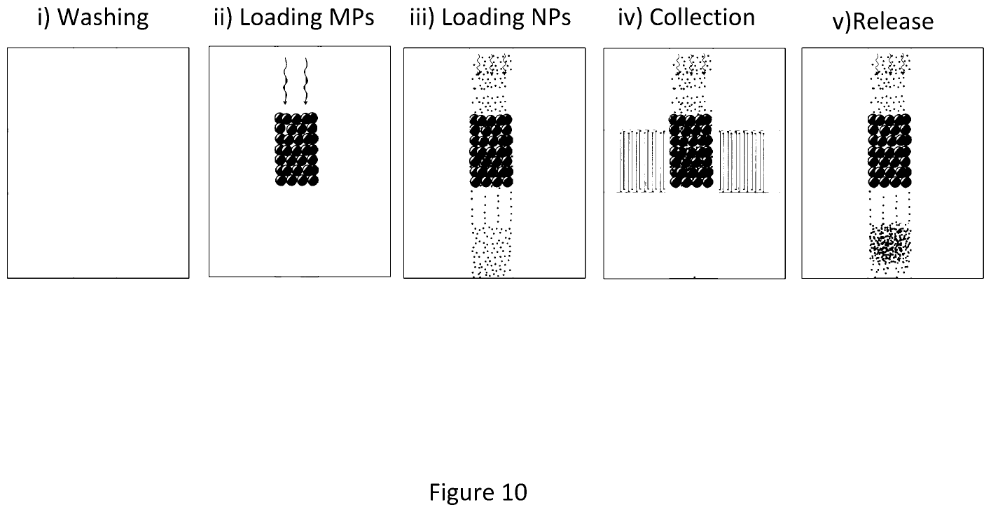

The channel used to assess the principle of using microparticle resonance to capture nanoparticles is relatively small, measuring 20 μm by 94 μm (height and width, respectively) this limited size allowed for accurate characterisation and visualisation of the bed. At one end of the channel, a row of pillars were fabricated with a gap size of 6 μm. Either side of the channel, electrodes were deposited on a piezoelectric substrate, the downstream end of these electrodes aligned with the pillars in the channel. This pair of interlocking electrodes (or interdigital transducers, IDTs) were used to excite the SAW. The first stage of experimentation was to load the channel with non-fluorescent 10 μm PS particles, the pillars at the end of the channel ensured that these particles were trapped and formed a small packed bed. Subsequently, a 0.04% w/v solution of fluorescent 500 nm PS nanoparticles was pumped through the packed bed at a flow rate of 1 μL/hr. The sequence of loading and operating the system is shown in FIG. 10i to v which respectively show schematic illustrations of the system that shows the sequence of the loading of microparticles (MPs) and then nanoparticles (NPs). Nanoparticles can be collected on demand by activating the sound wave (here SAW generated by interdigital transducers (IDTs)) and the high concentration sample can be released by switching off the sound wave. The locations of the nanoparticles within the channel was assessed en masse, by examination of the intensity of the fluorescent signal using video microscopy. When the nanoparticles pass through the packed bed without being attracted to the microparticles an approximately uniform intensity distribution is expected. An intensity increase in the area of the packed bed, and a drop in intensity downstream from the bed indicates entrapment occurring; whilst a reversal of this intensity distribution, i.e. a higher intensity downstream of the bed, indicates the release of nanoparticles after a trapping event has taken place. These intensity changes have been accentuated by using a very high nanoparticle concentration. FIG. 3 shows an example of this, as the surface acoustic wave actuation is turned on and then off, indicating a clear concentration event occurring within the bed during the period of actuation.

FIG. 3 shows the intensity change demonstrates 500 nm NPs collection (when SAW is ON) and further release of enriched batch (after SAW is switched OFF) in a 50 μm wide channel with the packed bed of non-fluorescent 10 μm MPs at the upstream, while a part of upstream and downstream selected as depicted by blue and green dashed boxes, respectively, to track the intensity level change during the experiment at the frequency of 68 MHz and the source power level of 15 dBm.

### Optimum Frequencies

The inventors, first, used these changes in measured intensity to assess the effect of changing the frequency of excitation, to probe the role of resonance. To make an accurate comparison across excitation conditions, the inventors ran a single experiment (to avoid any changes to the externally imposed flow conditions or the microscope settings) in which the excitation was repeatedly turned on and off, with each new cycle being at a higher frequency. To achieve this the inventors used chirped IDTs (i.e. electrodes with spacing), to provide a wide bandwidth over which useful data can be obtained, and are designed such that the particle resonance is within this bandwidth.

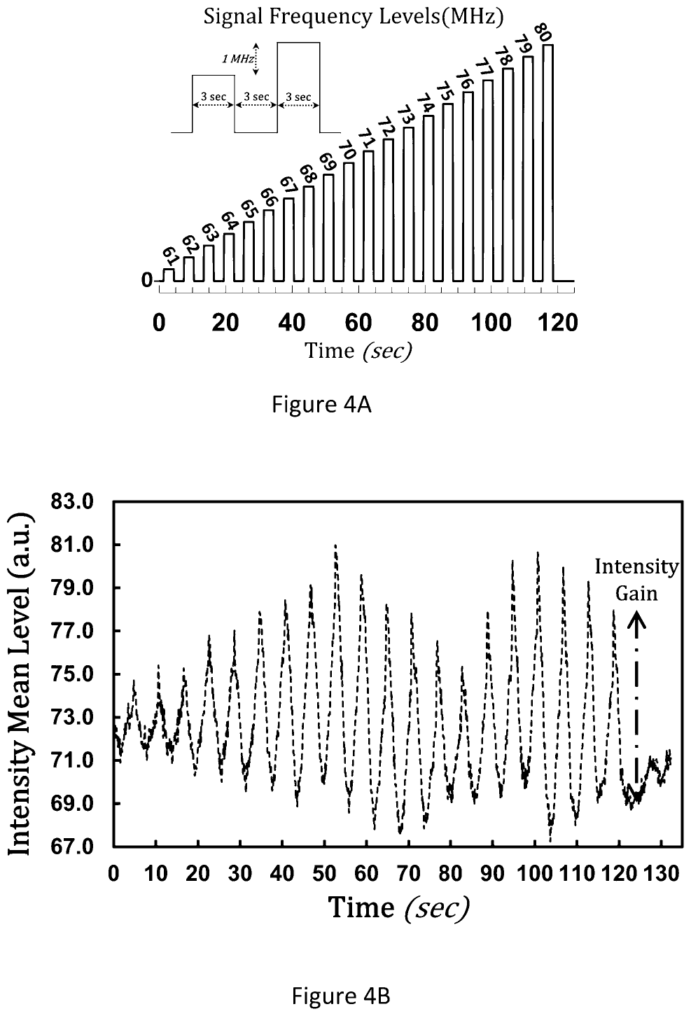

Whilst sweeping through the frequencies, a stepped rectangular pulse with fixed power level was applied as shown in FIG. 4a. The frequency range was 61 MHz to 80 MHz with each pulse 3 seconds long followed by a 3 seconds off period (to allow the previously captured particles sufficient time to be washed out of the packed bed by the fluid flow). Over the actuation period the intensity was been summed over a fixed area of the packed bed, and is shown in FIG. 4b.

FIG. 4 respectively shows a) stepped rectangular pulse with a 3-second pulse width and 1 MHz step. The power level is constant along the sweep; and b) The average Intensity level of the upstream side of the 94 μm wide channel during the frequency sweep. At each step, the intensity gain is calculated from the lowest to the highest level for each step. Results are depicted for 5 dBm power level.

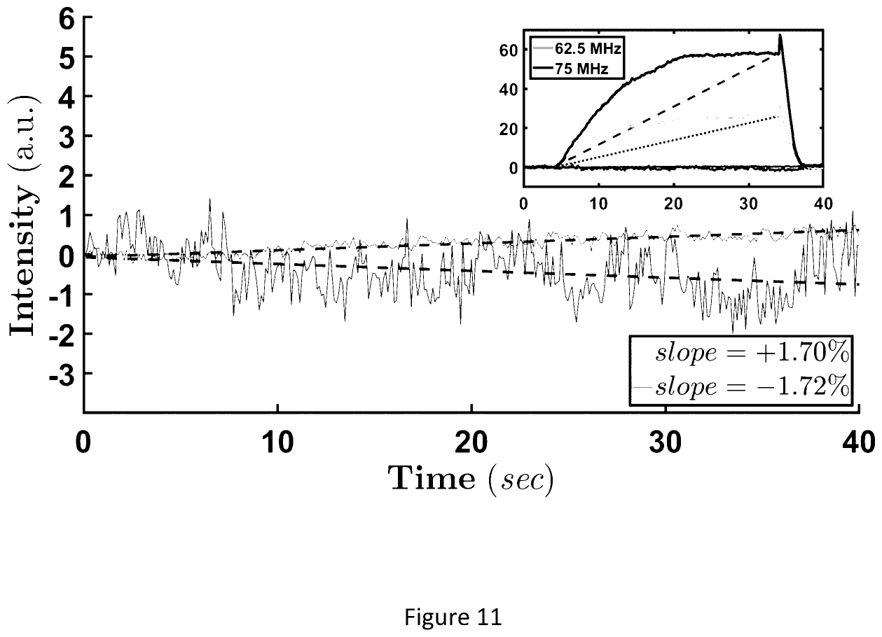

Prior to analysing the data, it is worth noting that although the upstream side of the pillars is fully packed by 10 μm particles over a length of considerably longer than the 500 μm long IDTs, in the absence of excitation, the hydrodynamic influence in collection of the nanoparticles is minimal and can be neglected. The intensity varies a range of just ±2%, see FIG. 11, whilst, in comparison the sound wave activated collection growth rates are 50% and higher within the same time period of 30 s (significantly longer than that used in the data shown in FIG. 4) and experiment conditions. FIG. 11 shows the instantaneous intensity level at the upstream of the channel (width 94 m) without activating the SAW, at two extreme cases that have the highest average linear intensity growth (both ascending and descending). When compared with intensity level growths by energised SAW (here are shown for 2 different frequencies of 62.5 and 75 MHz activated for 30 seconds in the inset), the intensity change due to hydrodynamic effects is insignificant and thus negligible.

A second control is the examination of the effect of SAW actuation in the absence of the microparticles, specifically looking at whether the acoustic radiation effects are sufficient to collect the nanoparticles without the Bjerknes forces which the microparticles generate. Under such conditions, whilst some of the nanoparticles were collected along nodal lines, they were not held against the flow so there is no decrease of presence downstream during actuation.

As a result of these two controls, the rise in the intensity seen as the SAW is actuated in FIG. 4b can be attributed to nanoparticle collection caused by secondary force arising from the presence of the microparticles. Within the short period of each actuation step, the intensity's growth is approximately linear and its gradient or gain (as depicted in FIG. 4b) can interchangeably be considered as a measure of NP collection.

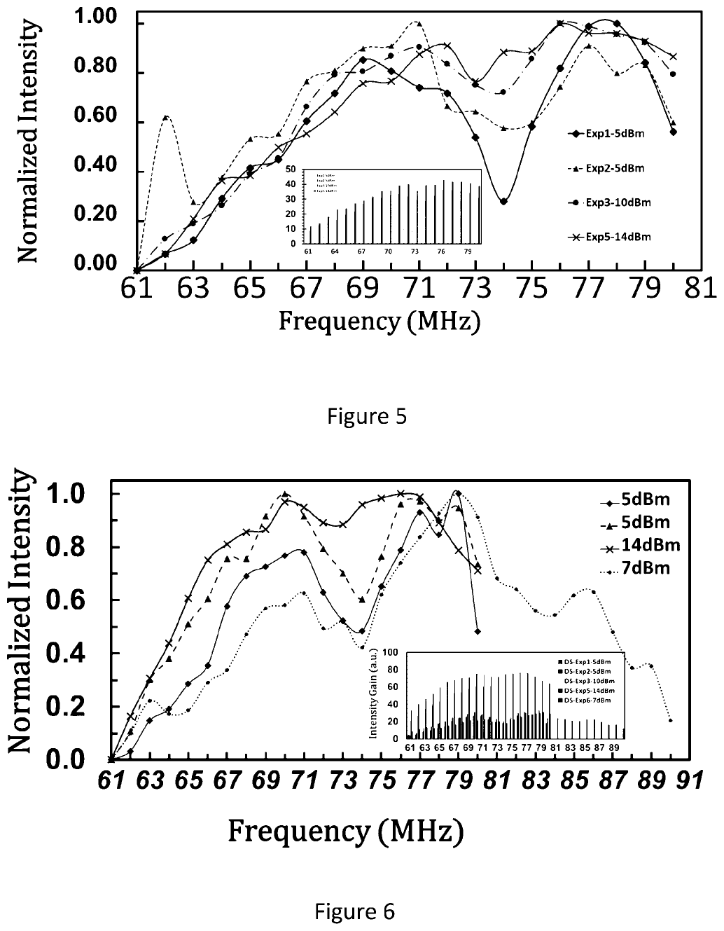

FIG. 5 shows the normalised intensity gain for SAW frequency from 61-80 MHz in a 94 μm×20 μm channel for 3 different power levels. Inset image shows the absolute intensity gain of each frequency for different power levels before normalising.

In FIG. 5, the intensity gain at each frequency is shown from FIG. 4b, in addition three other experimental conditions have been analysed. It can be seen that in each case there is a rise in the intensity gain with frequency to an initial peak, at 69 to 72 MHz (simulations predicted 65.7-67.5 MHz, see Table 1) followed by a dip and then a second peak at 76-78 MHz (simulations predicted 82.5 MHz). The dip in performance, within this frequency range, occurs at 74 MHz (71.2 MHz was predicted).

The slight shift of peaks and troughs in the experiment from the simulation prediction can be attributed the fact that in numerical model material properties are set to a macro-scale reported value while microbeads mechanical stiffness and density may differ slightly that can shift the resonance frequencies and change the mode shapes accordingly. Nonetheless, from these experimental results, it is clear that the behaviour of the packed bed is closely linked to the resonance behaviour of the microparticles. The key features being two peaks and one trough between 60 and 90 MHz, a greater attraction force in the second peak (Region C) compared to first one (Region B) and an eventual drop of the attraction force (accordingly NP collection) toward higher frequencies.

It is worth noting that the dip in performance is less pronounced for the two experiments conducted at high power in FIG. 5, it is believed that this is because the packed bed is becoming saturated at the higher optimum drive frequencies so the intensity rise seen for them are limited. This saturation can occur very quickly due to the high concentration of nanoparticles used. For most applications a much lower concentration would be expected, however for the purpose of characterisation the intensity changes are more reliable using such high concentrations (at lower power levels). To explore this further a set of experiments was conducted over a larger range of powers, as shown in FIG. 6. FIG. 6 shows the downstream results of the normalized intensity gain within the range of 61 to 90 MHz for different power levels, in a 94 μm×20 μm channel. The trend is similar to numerical simulation with a slight shift in peak/trough frequencies. Inset image shows the absolute intensity gain of each frequency for different power levels before normalising where higher power level provides greater intensity level in the same setup, i.e. higher collection.

Here, consistency is seen across the 5 and 7 dBm cases, with the 14 dBm being the outlier in that this power is sufficient to capture the particles even at non-optimal frequencies. In addition, a set of data is included that encompasses higher frequencies. Within in the range previously examined, the trends are very similar, indicating this is a phenomenon related to the microparticles rather than a quirk in the performance of the IDT sets, above this range we see a further drop in performance which also agrees with simulations.

### Power Sweep

We have seen that the relative gain achieved by using the optimum excitation frequencies (70±2 and 77±2 MHz at the case of 10 μm PS beads of the packed bed), influenced by PS resonance frequencies, play an important role, especially at low powers, and at which we observed a peak-trough difference in the order of 60-70%. At higher powers, this contrast differed (between 12 and 23%) due to saturation. Here, however, the inventors examine the effect of power more thoroughly, and examine the performance (via intensity changes) as a function of power, using a swept power experiment.

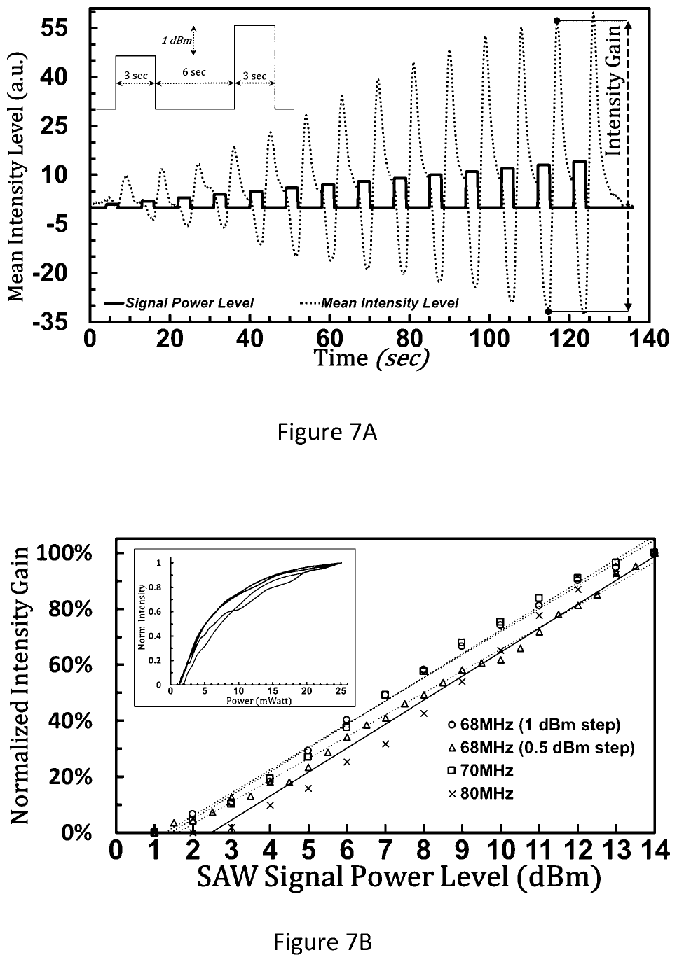

To investigate the power effect on the nanoparticle collection as it was observed in the frequency sweep that higher power levels provide greater intensity level, similarly, a stepped rectangular SAW pulse was introduced to the system. Starting from 1 dBm (equivalent 1.26 mW), each pulse lasted for 3 seconds followed by a 6-second off period and the step level increased 1 dBm at each increment up to a limit of 14 dBm (equivalent to 25.12 mW). The pulse diagram along with real-time mean intensity level for the downstream of the 94 μm×20 μm channel is depicted in FIG. 7.

FIG. 7 respectively shows a) the instantaneous mean intensity level at downstream side of 94 μm×20 μm channel at 68 MHz (in red) with the stepped pulse power sweep 1 to 14 dBm; and b) normalized intensity gains of different frequencies shows linear compliance with power level in dBm, thus a logarithmic leaning against power levels in mWatt.

### Capturing Performance and Enrichment Return

### Capturing Efficiency

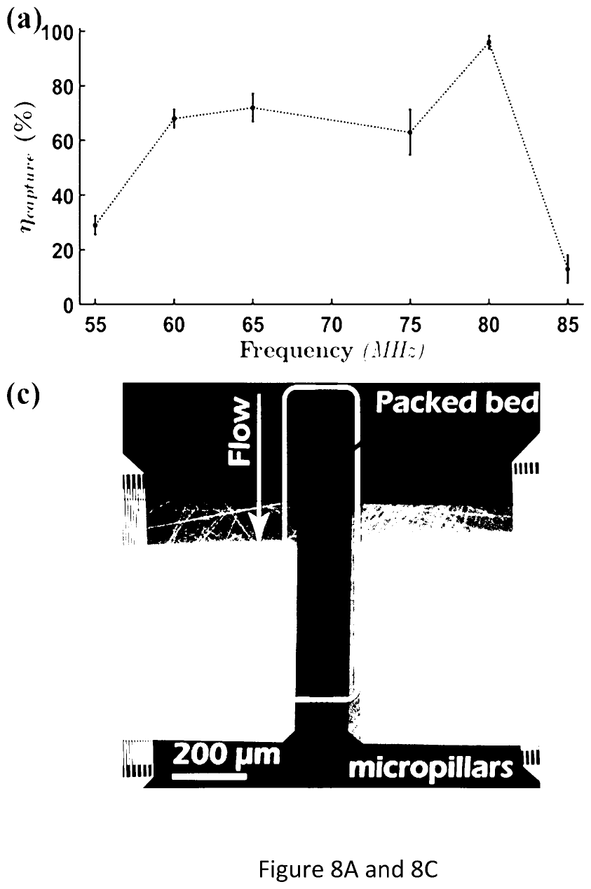

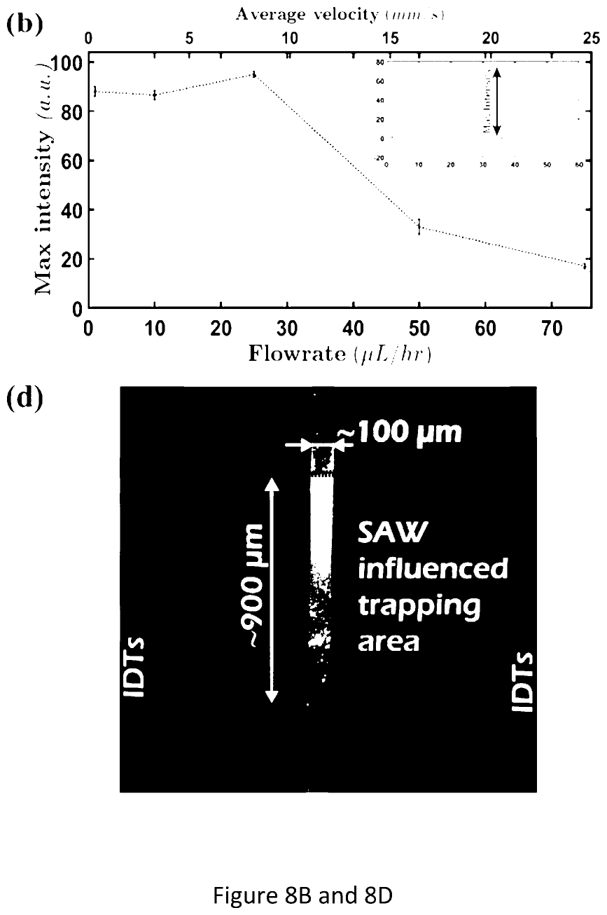

To investigate the capturing performance of the separation, filtration and/or enriching device, a further set of experiments was run. This was done over a range of frequencies, but here each actuation was sustained for a longer period of time than used in the frequency sweep experiment. The range used was between 55 MHz and 85 MHz (as representative from different regions) at a fixed power level of 12 dBm (at the port of source signal generator). The flow rate was kept at 1 μL/hr in a 94 μm×20 μm channel and the intensity level was measured downstream of the micropillar posts and was used to quantify the percentage of NPs which were not trapped. Ideally, if all NPs are trapped at the upstream, the light intensity emitted from fluorescent NPs in the downstream area will drop to zero upon actuation, hence, the capturing performance of the nanoparticle sieve is 100. The results, although only for representative frequencies, show a similar trend that by increasing the frequency the capturing efficiency also increases reaching a peak and drops after that. It can be seen that at frequency 80 MHz (very close to the second peak discussed earlier) we can achieve a capturing efficiency, η_{capture}, of approximately 97%, see FIG. 8 a. FIG. 8 respectively shows a) the capturing efficiency at selected frequencies at fixed power level 12 dBm in a 90×20 channel; and b) The effective trapping area of the packed bed. Microparticles out of this area at the upstream has a negligible part in the capturing.

For other frequencies, increasing the power will increase the intensity at the upstream and symmetrically decrease it at the downstream, as it can be seen FIG. 7a, in other words, a higher capture efficiency is achievable.

It is worth noting that at such high capture rates, a further increase in power would not make a difference to the intensity which is observed, this too (along with saturation of the bed) explains why in the frequency sweep experiments at the highest power used, 14 dBm, operation at the optimal frequencies is not seen to provide more capture than off resonance.

### Enrichment Return

Realising the optimum frequency and power level that provides a reasonably high capturing, the final concentration of the trapped batch of nanoparticles will be a function of time, channel size and flow rate. After a certain time of SAW being active, t, in a flow with a known flow rate, Q, and initial concentration, Ri, the mass of nanoparticles trapped in the trapping area, mNP and final concentration, Rf is:

$$\begin{matrix}{m}_{NP} = {η}_{capture} {QR}_{i} t & ( 1 ) \\ {R}_{f} = \frac{{m}_{NP}}{{V}_{chamber}} & ( 2 )\end{matrix}$$

where η_{capture} is the capturing efficiency of the separation, filtration and/or enriching device at a particular SAW condition (frequency and power) and V_{chamber} is the volume of the trapping area. This area only encompasses the SAW influenced part of the whole packed bed. While in the tested devices, after loading the MPs, the packed bed fills and covers areas beyond the SAW beam, however microparticles outside this area are not observed to assist in NP trapping. To confirm this, FIG. 8d shows that in a 94 μm×20 μm channel at the end of an experiment with 200 nm PS particles, the SAW activated area clearly has a brighter intensity (due to the collection of NPs) than parts of the pack bead upstream of the SAW beam. The inventors used V_{chamber} to define the volume of this part and for the case shown in FIGS. 8c and d. It is about V_{chamber}=900×100×20(μm)³=1.8 nL. Rearranging equations 1 and 2, the concentration return can be expressed as follows:

$${R}_{f} / {R}_{i} = {η}_{capture} ( Q / {V}_{chamber} ) t \qquad ( 3 )$$

This is valid within short periods of time as enrichment cannot increase endlessly and linearly. In a set of experiments run in a 50 μm wide and 20 μm high channel at 70 MHz and 14 dBm SAW signal conditions, measuring the maximum intensity at the downstream (as an indication of the maximum captured nanoparticles with 500 nm size) against different flow rates, it can be seen that this maximum intensity is retained up to 25 μL/hr flow rate that corresponds with the average velocity of 6900 μm/sec, FIG. 8b. Assuming a conservative capturing efficiency of 0.7 at 14 dBm power level, within a 10 sec period of SAW operation the concentration return is about 54. Hence, the separation, filtration and/or enriching device has the capability of about 50-fold enrichment of the nanoparticle within a short time. By scaling up, the chamber volume, V_{chamber} increases and to keep the return ratio, the flow rate can increase thus enables the separation, filtration and/or enriching device to handle larger sample volumes.

### Effect of Nanoparticle Size

The inventors further investigated the operability of the separation, filtration and/or enriching device for smaller nanoparticles. The inventors characterisation of the role of frequency and power have utilised 500 nm polystyrene beads, taking advantage of the brightness of fluorescence they offer for high quality data collection. Their study clearly showed two ranges over which the collection of nanoparticles is optimal. In that study the power had to be limited in order to observe the effect of frequency, as at high powers a mixture of total capture and bed saturation caused a maximum intensity change to be reached. In terms of operation of the system, this clearly demonstrates that there is unused capacity in the operational range. Here, the inventors utilised this, by turning up the power, to address the more challenging task of capturing smaller particles. The inventors note here, that the broadband width chirped IDTs are still used for this task, and that this too offers additional scope for enhancement as single frequency IDTs are considerably more efficient, where 72 MHz is within the range of the first peak. To study how this set of conditions can be used to capture smaller objects, in a 94 μm×20 μm channel, experiments were separately performed for 190 nm and 100 nm polystyrene nanoparticles with 0.3% w/v and 0.007% w/v concentrations, respectively, both at 1 μL/hr flow rate.

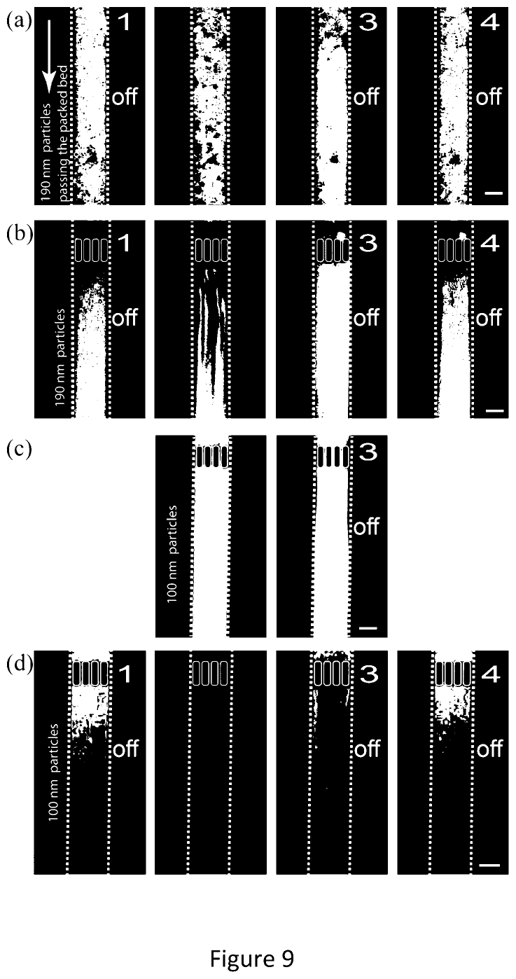

A 72 MHz (within the first frequency peak) SAW at 18 dBm and the amplifier's mini-mum gain (nominally at 26 dB) was used to activate the bed. FIG. 9a-2 shows the resulting intensity changes resulting from the capture of 190 nm particles in the bed, whilst down-stream clarification of the solution is seen in FIG. 9b-2. Upon turning off the ultrasonic actuation, the concentration of nanoparticles at the upstream drops quickly with the transition region between high and low intensity moving downstream with the flow (FIGS. 9a-3 and b-3). A few seconds after the end of SAW activation, the fluorescent intensity returns to its initial level (captions 4 of FIGS. 9a and b).

FIG. 9a to d respectively show the upstream and downstream views, respectively, of trapping 190 nm polystyrene particles, where captions demonstrate (1) before SAW activation, (2) during SAW activation, (3) instantly upon turning off the SAW and (4) seconds after activation ends. The power level at source 18 dBm and amplifier at minimum level c) The downstream view of SWANS with 100 nm polystyrene shown at stages (2) and (3). The capturing occurs, however, it is not significant due to the smaller size of the NPs. Power level 18 dBm and amplifier gain at a minimum. d) Capturing of 100 nm polystyrene beads is shown where the intensity drops while SAW is activated (2) and noticeable release of enriched batch upon turning the SAW off (3). The amplifier gain increased. The arrow shows the flow that is downward for all captions and the scale bar is 50 μm.

Similarly, 100 nm particles solution went through collection, enrichment and release cycle at 72 MHz frequency and 18 dBm power level (with the amplifier's minimum gain), however, due to the smaller size of the 100 nm particles although the collection takes place and the release of trapped particles can be observed from FIG. 9c-3, is it less distinct. The acoustic radiation force on nanoparticles can be presumed to be proportional to the volume of the particle, hence to the cube of its diameter, based on earlier studies. The simulation of 100 nm polystyrene particle in proximity of a 10 μm polystyrene particle, in like manner described and demonstrated in FIG. 2, shows that total acoustic radiation force and accordingly the secondary force on the nanoparticle is proportional to the cube of particle size. To counter this, further increase in the power shows more clearly evident collection of 100 nm particles in otherwise identical conditions (FIG. 9d). The comparison of stages 2 and 3 of FIGS. 9c and 9d demonstrates that adjusting to a suitable power level effectively traps 100 nm particles at the packed bed (evident from the intensity drop at the downstream) and swiftly releases the enriched batch with its propagating front to the downstream.

The series of experiments have been designed to demonstrate the role of microparticle resonance in the capture of nanoparticles. To this end, several requirements were imposed for the acquisition of high quality data on the role frequency on performance. It was necessary to use relatively large particles (500 nm) such that the image intensity was significant, and to perform the experiments in a small system to further assist visualisation. It was then observed that at high powers, the role of frequency is blurred by the fairly efficient capture at even sub-optimal frequencies. The inventors have referred to the necessity to drop the power level to observe the resonant behaviour as demonstrating excess operational capacity, and then utilised that capacity to capture smaller particles. However, it is also worth noting that the intensity of the sound field can further increased by more efficient transduction from electrical power into surface acoustic waves. To study frequency effects it has been necessary to use a broadband IDT set with variable pitch electrodes, in which the optimum pitch for SAW generation only occurs across a few electrodes. Operation of a single frequency, constant pitch, IDT offers considerably more efficiency, and hence additional capacity for improved performance.

### SUMMARY

The concept of a mechanically activated packed bed has been presented and shown to be capable of entrapment and enrichment of nanoparticles in a continuous flow. The activation is in the form of ultrasonic excitation which is shown, both numerically and experimentally, to be most efficient when the frequency is chosen such that in coincides with a resonant mode of the microparticles forming the packed bed. Under this condition, firstly, the bed itself is stable as the microparticles are attracted to each other. Secondly, when a solution of nanoparticles pass through the bed, they too are attracted to the microparticles and become captured on their surface. Hence filtration is obtained without the need for chemical functionalisation of the bed, and in a manner which is reversible, such that an enriched sample can be collected. The filtration does not block the bed, and, in contrast to membrane filtration, the pore size is dictated by the size of the microparticles rather than the nanoparticles. At a power of 12 dBm, 97% of the 500 nm passed through a bed activated at a resonance frequency of 80 MHz were collected. In addition collection was shown at higher powers of both 190 and 100 nm particles. As the resonance is related to the components of the bed, rather than the bed size, there is excellent potential for upscaling, having, in this worked, demonstrated the underlying physics.

### Materials and Methods

### Simulation

To understand the physics behind the particles' interaction in a one-dimensional standing wave, a 10 μm and a 500 nm sphere with polystyrene material were modelled in COMSOL Multiphysics® 5.1 Acoustics module. The solid domain was attributed to the spheres with user-defined polystyrene materials (1050 kg/m3 as density, 3.69 GPa as Young's modulus and 0.3 for Poisson ratio) and for surrounding domain water selected from COMSOL's database. To investigate single polystyrene microparticle frequency regions and its inter-particle interaction with 500 nm nanoparticle, we established the model in Axisymmetric 2D geometry. However, for multiple microparticle scenarios, the more time efficient 2D geometry was applied in lieu of full 3D geometry.

### Fabrication

Microchannels with widths of either 50 μm or 94 μm and height of 21 22 μm were designed in AutoCAD and a silicon master mould was fabricated by positive photolithography, chromium deposition as an etching mask and DRI etching of silicon to the desired depth. Microchannel chips were produced by polydimethylsiloxane (PDMS; 1:10 ratio of curing agent/base) soft lithography on the Si mould.

The substrate onto which the PDMS component is bonded, is a lithium niobate (LiNbO3, LN) wafer (128° Y-cut). The deposition of metal electrodes on this piezoelectric material forms interdigital transducers (IDTs) capable of the generation of SAW. Specifically, broadband (chirped) IDTs with 1.14 mm aperture were aligned 45 deg relative to the x-propagation direction and two different wavelength ranges, 14-60 μm and 20-70 μm were used. IDT fingers and contact pads were fabricated from a 5-nm-thick Cr primer layer, 190-nm-thick Al conductive layer and 5-nm-thick Au corrosion protective layer. Another 250-nm-thick layer of SiO2 was deposited on top of the IDT area for further protection against erosion and better bonding to PDMS. The electrodes were fabricated via conventional photolithography technique followed by E-beam evaporation deposition, lift-off and finally cutting by dicing saw. The PDMS microchannels were bonded onto the LN substrate after plasma treatment (Harrick Plasma, PDC-32G). The SAW that is generated on the surface of LN loses its energy due to attenuation when propagates further in particular when transmitting through PDMS bulk material. To minimise SAW attenuation, PDMS microchannel chip has air pockets incorporated on top of IDTs with a thin 60 μm wall isolating each from the test channel. The 10 μm beads used as microparticles (MPs) for trapping were non-fluorescent dark red and made of polystyrene (Magsphere, USA). Three different sizes of polystyrene fluorescent nanoparticles ((Magsphere, USA) were used, 500 nm in red, 190 nm in yellow-green and 100 nm in red. Solid particles were suspended in a water solution of 2% polyethylene glycol to avoid particles attachment to channel walls. Prior to each experiment run to achieve a homogeneous suspension, the sample was shaken by a vortex mixer.

### Experiment

The experiment setup consists of a signal generator (SMC100C, Rhode & Schwarz) and amplifier (25A250A, Amplifier Research) connected to LN chips to generate SAW and micro/nanoparticles suspensions were injected to the PDMS microchannels using the syringe pump (KD Scientific). All test were observed under an upright microscope (BX43, Olympus) via fluorescent light filters (Olympus and Edmund Optics). All images and videos captured by top mounted digital camera (Pixelink PL-B782CU and DinoCam). To facilitate timely operation of signal generator, it was commanded by MATLAB® and simultaneously video capturing were triggered by MATLAB® Image Acquisition Toolbox™.

### Data Analysis

The fluorescent light intensity of the videos was processed and analysed by MATLAB to indicate the level of nanoparticle capture and release. As the collection of nanoparticles occurs randomly all over the packed bed area, the grayscale intensity level was calculated and recorded against time.

The above described experiments sought to demonstrate the feasibility of the microparticle and/or nanoparticle separation, filtration and/or enriching device and method according to the described embodiments. While the experiments were conducted using a microfluidic system, it is also envisaged that the described embodiments can be readily upsized to conventional sized packed bed as typically used for water filtration, gas drying, and reaction/distillation tower applications. Also, while the experiments utilised surface acoustic wave arrangement to generate the necessary acoustic actuation of the packed bed, it is also envisaged that alternative means be utilised to achieve acoustic excitation of the packed bed. For example, it may be possible to utilise bulk waves generated within a piezoelectric device for this purpose. In addition, while the experiments used microparticles formed from polystyrene, the use of alternative materials for the microparticles such as metal to modify the resonance frequencies of the packed bed is also envisaged.

### Filtration/Separation System

Referring now to FIGS. 13A, 13B and 13C, there is shown a schematic of a filtration/separation system 100 comprising a filtration/separation/enrichment device 100, such as microfluidic device 1 of FIG. 1, or the microparticle and/or nanoparticle separation, filtration and/or enriching device, as discussed above. In FIG. 13A, the filtration/separation/enrichment device 102 is in an off state, in FIG. 13B, the filtration/separation/enrichment device 102 is in an activated state (filtration state), and in FIG. 13C, the filtration/separation/enrichment device 100 is in a deactivated state (separation state), as will be discussed in more detail below.

The system 100 comprises a container 104 for receiving and retaining a liquid suspension to be conveyed to the device 102. The container 104 is coupled to a pump 106, which when activated, is configured to cause the liquid suspension to be conveyed along a conduit 108 to the device 102, and more particularly, to a flow passage or channel 110 of the device 102.

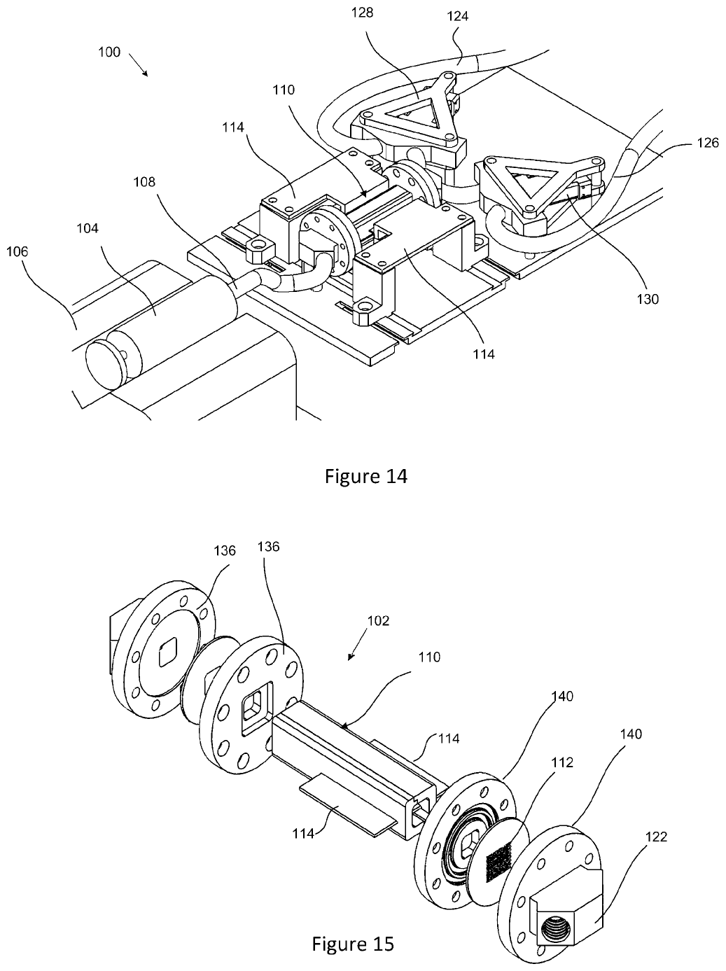

The device 102 comprises a barrier 112, such as a membrane or pillars, physically retained within the flow passage 110. The barrier 112 is configured to trap microparticles to thereby form a packed bed of microparticles. Accordingly, when the liquid suspension is conveyed to the flow passage 110, it passes through the packed bed of particles and the barrier 112. For example, the barrier 112 may span a cross section of the flow passage 110. In some embodiments, as illustrated in FIGS. 14 and 15, the barrier 112 is located at or toward an end of the flow passage 110, and may be disposed between two gaskets 140 provided toward the end of the flow passage 110, with the packed bed forming behind the barrier 112. For example, a membrane with suitable mesh size disposed towards the outlet 122 side gasket 140 may retain the microparticles inside the flow passage 110 and build the packed bed, while allowing the media and smaller nanoparticles to pass through. The in-line built packed bed generates hydrostatic pressure which depends to the size of the microparticles, packing density and length of the packed bed.

In addition to the flow passage 110, the device 102 further comprises an ultrasonic actuation system 114 for mechanically activating the or each packed bed. In some embodiments, the ultrasonic actuation system 114 may comprise an signal generator 116, or similar instrument, to allow for selective control of the operation of the ultrasonic actuation system 114, and in particular selective control of the frequency and power of operation. The signal generator 116 may be coupled to and controlled by a computing system or device 118.

In some embodiments, interdigital transducers (IDTs) on lithium niobate substrate is used to generate SAW inside the flow passage 110, and in particular the bottom of the flow passage 110. In some embodiments, the ultrasonic actuation system 114 comprises a transducer, which can be positioned outside of the flow passage 110 and may in be in the form of a plate transducer or ring transducer as the resonance of the particles in the packed bed mostly depends to the excitation frequency. Ultrasound signals from the signal generator source may come through the PCB board to feed the IDT.

An outlet 120 of the flow passage 110 is coupled to a multi-way connector or flange 122 providing fluid communication with a plurality of respective channels. In the embodiment depicted in FIGS. 13A, 13B and 13C, the multi-way connector 122 is a dual connector providing for fluid communication between the outlet 120 and a first channel 124 and with a between the outlet 120 and a second channel 126. The first and second channels 124 and 126 are provided with respective first and second switches, 128, 130, which can each be activated to allow or impede (or stop) the flow of fluid through the channels. For example, and as illustrated in FIGS. 13A, 13B and 13C, the first and second switches may be solenoid valves, and may be coupled to and controlled by the computing system 118. First and second receptacles 132 and 134 may be disposed at an end of each of the respective first and second channels 124, 126 to collect flow conveyed thereto.

FIG. 14 is an isometric view showing a part of the system 100 of FIG. 13A, showing more clearly the device 102 and its components, according to some embodiments.

FIG. 15 is an exploded view of the device 102, which depicts inlet flanges 136 (between which is generally places a gasket or O-ring (not shown)) of the device 102, and outlet flanges 140 (between which is generally places a gasket or O-ring (not shown)), according to some embodiments. As mentioned above, the connector 122 can be a multi-way connector so that after each cycle of collection/separation, the separated (nano)particles may be diverted to other channels or tubes to be collected/extracted in separate container, while during the mechanical activation of the packed bed, the filtered media is switched to its designated channel and collection container.

In operation, unprocessed media is loaded into the container 104. A collection/filtration cycle is started by the computing system 118 causing the first valve 128, for example, the ‘filtered/process valve’ to be activated (i.e. turned ON), triggering an ultrasound signal to cause the ultrasonic transducer (here inserted into the channel, though external arrangements would also be possible) 114 to generate a sound wave to activate the packed bed of particles. As long as the ultrasound signal is ON, the filtration occurs and the nanoparticles are trapped and collected inside the flow passage 110.

At the end of a collection cycle, the computing system 118 is configured to turn OFF the ultrasound signal, to turn deactivate (i.e. turn OFF) the first switch (for example, the ‘filtered/processed valve’) and to activate (i.e. turn ON) the second switch 130 (for example, the ‘Separated (enriched) particles’ valve), to thereby cause the system to deliver or convey the separated (nano)particles to the second receptacle 134.

When the whole separated batch has been extracted, the ‘Separated (enriched) particles’ valve is turned OFF and ‘filtered/processed valve’ is turned ON (open). Another collection/filtration cycle starts immediately by turning the ultrasound signal ON and consequently another separation step follow after.

While the flow is continuous, these cycles of filtration and separation is repeated till the whole sample is processed, even the processed sample can be recycled multiple types to ensure all (nano)particles are captured. In this way, the system 100 may be configured to perform continuous filtration by activating the switches 128 and 130 to cause the filtration and separation of particles, with the separated/enriched particles being selectively conveyed into a particular channel 124, 126 of a plurality of channels at an end of each collection cycle.

In some embodiments, the system 100 may be up-scaled to handle relatively large sample volumes (Q) is to increase the cross-section area of the flow channel 110 and to increase the volume of the packed bed of particles (V_{chamber}). By increasing the chamber volume, the flow speed can remain relatively low, but at a level that does not significantly impact the capturing efficiency or cause it to drop. The flow passage 110, flanges 136, 140 and sealing of the system are designed in a way to accommodate for increased pressure arising from any increased volume of the packed bed in large scale.

### Effect of the Size and Material of the Packed Bed Beads

a. Expanding the Numerical Simulation to Include Travelling Waves

The one of more packed beds of particles may be formed of multiple layers of randomly packed particles. However, considering the typically spherical shape of the particles (for example, microbeads) and the vibration induced by the ultrasound wave, a face-centred cubic (FCC) or hexagonal closed-packed (HCP) form of packing can be assumed in most cases. In this dense packing scenario, nanoparticles tend only to pass through the pores between the spheres either in the horizontal or vertical direction. The geometry, in other words, the size of the spheres, dictates the pore size; the larger the sphere, the larger the pore. When the packed bed is at rest, it is fair to assume that the nanoparticle will tend to pass through the centre of the pore.

The packed beds of particles may be formed from particles that have any suitable shape and size that allows for the formation of pores when the particles are arranged in the packed bed (e.g. following self-assembly). For example, the particles may be at least substantially uniformly sized, shaped particles having the same physical properties. The particles may be generally spherical in shape. It is however also envisaged that the particles have an alternative shape including, but not limited to, ellipsoids, cylinders, pillars/rods and fibres (such as paper fibres, arbitrary shaped pillars and particles). Other shapes are also envisaged, provided one or more pores are formed when the particles self-assemble in the packed bed. The backed bed of particles may also comprise two or more sets of particles with different morphologies (e.g. a mixture of spherical and rod particles).

The particles may typically have an aspect ratio (i.e. the ratio of a length to a width, where the length and width are measured perpendicular to one another, and the length refers to the longest linearly measured dimension) of 1.0 to 2.0, for example about 1.0, 1.1, 1.2, 1.3, 1.4, 1.5, 1.6, 1.7, 1.8, 1.9, or 2.0. In one embodiment, the particles have an aspect ratio of about 1.0, e.g. are isotropic in shape, such as spherical In another embodiment, the particles have an aspect ratio of greater than 1.0, e.g. are anisotropic in shape such as elliptical. The packed bed may also comprise a mix of particles having different aspect ratios (such as ellipsoids, cylinders, pillars/rods and/or fibres).

The particles of the packed bed may have any suitable size. The size, e.g. diameter (d), may be defined with reference to the wavelength (λ) of the resonance frequency. For example, the packed bed may be mechanically actuated at a frequency having a wavelength (λ), and the particles of said packed beds may have a diameter (d) in the range of around less than 0.3λ to 0.67λ, for example less than around 0.3λ, 0.31, 0.32λ, 0.33λ, 0.34λ, 0.35λ, 0.36λ, 0.37λ, 0.38λ, 0.39λ, 0.40λ, 0.41λ, 0.42λ, 0.43λ, 0.44λ, 0.45λ, 0.46λ, 0.47λ, 0.48λ, 0.49λ, 0.50λ, 0.51λ, 0.52λ, 0.53λ, 0.54, 0.55λ, 0.56λ, 0.57λ, 0.58λ, 0.59λ, 0.60λ, 0.61λ, 0.62λ, 0.63λ, 0.64λ, 0.65λ, 0.66λ, or 0.67λ. The diameter (d) of particles in the packed bed may also be provided in a range between any two of these values. In some embodiments, the packed bed may be mechanically actuated at a frequency having a wavelength (λ), and the particles of said packed beds may have a diameter (d) in the range of around less than 0.32λ to less than 0.61λ. Other (d) ranges are also contemplated.

In some embodiments, the packed bed may be mechanically actuated at a frequency having a wavelength (λ), and the particles of said packed beds may have a diameter (d) in the range of around 0.3λ to 0.67λ, for example around 0.3λ, 0.31λ, 0.32λ, 0.33λ, 0.34λ, 0.35λ, 0.36λ, 0.37λ, 0.38λ, 0.39λ, 0.40λ, 0.41λ, 0.42λ, 0.43, 0.44λ, 0.45λ, 0.46λ, 0.47λ, 0.48λ, 0.49λ, 0.50λ, 0.51λ, 0.52λ, 0.53λ, 0.54λ, 0.55λ, 0.56λ, 0.57λ, 0.58λ, 0.59λ, 0.60λ, 0.61λ, 0.62λ, 0.63λ, 0.64λ, 0.65λ, 0.66λ, or 0.67λ. The diameter (d) of particles in the packed bed may also be provided in a range between any two of these values. In some embodiments, the packed bed may be mechanically actuated at a frequency having a wavelength (λ), and the particles of said packed beds may have a diameter (d) in the range of around 0.3λ to 0.45, 0.31λ to 0.45λ, 0.32λ to 0.60λ, 0.32λ to 0.61λ, 0.32λ to 0.41λ, 0.32λ to 0.415λ, 0.415λ to 0.6λ, 0.415λ to 0.61λ, or 0.45λ to 0.67λ. Other (d) ranges are also contemplated.

Alternatively or additionally, the size of the particles of the packed bed may be defined independent of the wavelength of the resonance frequency. In some embodiments, the average particle size (such as diameter) of the packed bed particles may be between about 1 μm and 1000 μm, for example, about 1 μm, 2 μm, 5 μm, 10 μm, 15 μm, 20 μm, 25 μm, 50 μm, 75 μm, 100 μm, 200 μm, 500 μm, 700 μm or 1000 μm. Although smaller or larger particles are within the scope of this disclosure. The average particle size of the packed bed may also be provided in a range between any two of these values. In some embodiments, the average particle size of the packed bed may be between 1 μm and 100 μm, 1 μm and 50 μm, 1 μm and 30 μm or 1 μm and 20 μm. In one embodiment, the particles of the packed bed are microparticles. The size and shape can be determined using any suitable means, for example optical or electron microscopy and/or dynamic light scattering.

In some embodiments, the particles in the one or more packed beds 112 assemble to define a plurality of pores between the particles. The assembly may be non-ordered (i.e. form multiple layers of randomly packed particles) or may from an organized structure or pattern (e.g. self-assembly). For example, the particles may self-assemble to form a hexagonal closed packed (HCP), face-centred cubic (FCC), or body centred cubic (BCC) form of packing. As understood in the art, a HCP packing has a coordination number of 12 and contains 6 particles per unit cell. A BCC packing has a coordination number of 8 and contains 2 particles per unit cell. A FCC packing has a coordination number of 12 and contains 4 particles per unit cell. In some embodiments, where the particles in the packed bed self-assemble, the self-assembly may be ordered (e.g. a uniform packing across the packed bed e.g. HCP) or dis-ordered (e.g. a packing which alternates between one or more systems e.g. an alternative motif of HCP and FCC packing). Regardless of the type of particle assembly, it will be appreciated that the one or more packed beds 112 comprise a plurality of pores. In some embodiments, the pore can be described as being defined by three or more adjacent particles. For example, in an ideal self-assembled packing scenario (e.g. FCC or HCP), the plane crossing the centre of three adjacent particles make a plane that encompasses the narrowest passage (“pore”) between the particles where the liquid suspension supporting the microparticles and/or nanoparticles can pass through. These planes could be vertical, horizontal or diagonal. It will be appreciated that in some embodiments, the packing arrangement forms numerous “pyramid” assemblies comprising a set of four particles (for example three particles at the bottom and one particle sitting atop in the middle) interspersed throughout the packed bed, and the planes define the sides of the pyramid comprising a set of four particles.

The liquid suspension supporting microparticles and/or nanoparticles can pass through the pores. Depending on the size of the pores formed by the arrangement of the packed bed, some microparticles and/or nanoparticles may pass through the pores. This size selectivity may be beneficial where the liquid suspension comprises two more different types of particles of different sizes. Two or more packed beds comprising different sized particles and therefore different sized pores may be placed adjacent to each other, thereby separating and trapping microparticles and/or nanoparticles of different sizes from the liquid suspension as it passes through.

The number, shape and size of the pores in the packed bed is dictated by the number, size and shape of the particles. In some embodiments, the average pore size generated by the packed bed of particles may be between 1 nm and 10 μm, for example, about 10 nm, 20 nm, 30 nm 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm or 10 μm, although smaller and larger pore sizes are within the scope of this disclosure. The average pore size may also be provided in a range between any two of these values. In some embodiments, the average pore size an may be between 20 nm and 5 μm, or between 30 nm and 1 μm. The pore shape is dictated by the shape and size of the particles. The pore size may be taken as the largest distance between any two particles defining the pore. Alternatively or additionally, in one example, the pore size may be taken as the diameter of a notional sphere that could be assembled and housed within the void generated by the particles defining the pore (e.g. if a notional particle could theoretically self-assemble within the pore, in some embodiments, the pore size may be taken as the diameter of that notional particle). The packed bed may comprise pores with varying size, depending on the size, shape and/or packing of the particles throughout the packed bed. For example, the particles may be of different sizes and/or shapes resulting in varying packing arrangements within the packed-bed and consequently different sized pores. In another example, the particles may be uniform size and shape (e.g. spherical) however may self-assemble to form a dis-ordered packing structure which alternates between two or more packing motifs (e.g. HCP and FCC), which may give rise to different pore sizes within the packed bed.

Upon activation of the system 100 and excitation of the device 102, a surface acoustic wave (SAW) propagates along the surface of the substrate and when it reaches the liquid channel in the flow passage 110, it will couple into the fluid domain with Rayleigh angle. When propagating further, the SAW loses its energy (being transferred to the liquid domain) and around the centre of the flow passage 110 it will superpose itself on to the opposing incoming travelling SAW from other side. That will form a standing wave on the substrate at the midpoint between two opposing decaying travelling waves. If no sizeable solid object is present in the liquid form, the pressure field travels upward in the channel. However due to the PDMS-liquid impedance mismatching, a part of the energy will be reflected back to the channel and cause a pseudo-standing wave in liquid domain. Including solid particle spheres (for example, microparticles) in the liquid domain having sizes comparable with the acoustic wavelength, the wave is significantly scattered and distorted; it is no longer a simple planar wave, and we may yet assume that a mix of travelling and standing waves occurs in within the channel boundaries.

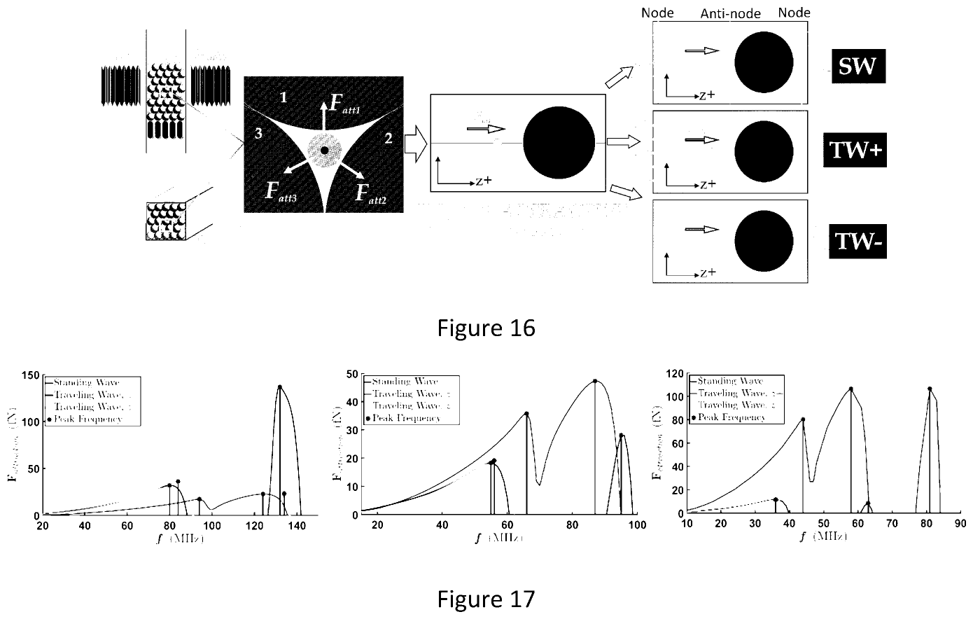

When flow passage 110 and packed bed of particles are excited with ultrasound SAW, the (nano)particles passing the pores will undergo primary and secondary acoustic radiation forces as well as acoustic streaming induced drag force. However, due to the small size of the (nano)particle, the primary force is negligible and due to the presence of the microbeads, the acoustic streaming may not develop. Even though microstreaming may occur in each pore between the spheres, the magnitude of the induced force can be assumed negligible in relation to the secondary acoustic radiation force or as it commonly known, the Bjerknes force. Each sphere will induce their own Bjerknes force on to the nanoparticle. However, as the position of the spheres in the sound field may be different, even assuming all three Bjerknes forces are ‘attractive’ thanks to the imbalance between these forces, the nanoparticle eventually will be closer to one the microparticle spheres. As the Bjerknes force scales with the inverse of distance to the higher powers (Fₐₜₜ ∝1/d² or 1/d⁴), the Bjerknes force from other two spheres will be weaker and weaker so can be neglected. Hence it is justifiable to present a model of single MP and single NP to investigate the frequency response of ‘attractive’ or ‘repulsive’ Bjerknes force at different wave forms for different MP size or materials. In view of this, a model of two solid spheres in an axisymmetric 2-dimensional geometry was built in COMSOL 5.1 Acoustic module, as illustrated in FIG. 16.

FIG. 16 shows the excitation of the device 102 and illustrates the three Bjerknes forces induced by a sphere. The packed bed has a very dense packing formation. So the smaller nanoparticle (NP) can only pass through pores between every three adjacent microparticles (MP). At the same time, each of them induces their attractive/repulsive force respectively, as the forces may not be in equilibrium, the NP eventually falls under the influence of one MP so the model of one NP-one MP is justified. The simulated model of the conditions in the flow passage 110 can include the scenarios where the pair can undergo standing wave (SW), assisting positive direction travelling wave (TW+) or hindering negative-direction travelling wave (TW−), as illustrated.

b. Frequency Response of Each Size

In previous experiments, the inventors focused on the results from a model only with pure standing wave. However, in view of the above insights, using SAW in a liquid channel with PDMS walls can generate a mix of standing and travelling waves. It will be appreciated that when other ways of ultrasound wave generation are used, such as bulk acoustic wave (BAW), either of standing wave or travelling wave or a mix of both can be formed in the acoustic domain.

In some embodiments, the or each packed bed is mechanically actuated at or near a resonance frequency of the particles forming the packed bed. Accordingly, a suitable frequency may be selected based on the size of the microbeads in the packed bed. The resonance frequency may be in the range of 50 MHz to 150 MHz, for example, for 7 and 10 micron particles. For larger particles, the resonance frequencies are typically lower (for example for 15 μm particle, the first peak frequencies occur around 40 MHz and so on). It will be appreciated that a mix of different particle sizes may form the packed bed, in which case the applied frequency would be at/near the resonance for some of the particles and off the resonance for other particles.

Referring now to FIGS. 17A, 17B and 17C, there is shown graphical representations of simulation results showing attraction force on a 500 nm polystyrene nanoparticle induced by a microparticle positioned at a gap that is adjusted for the size of the pore size where the NP passes through. For 7 μm particle, this gap is 300 nm (side-to-side) (FIG. 17A), for 10 μm is 500 nm (FIG. 17B), and for the 15 μm particles, it is 750 nm (FIG. 17C). When the size of the particle increased, the peak frequencies (f*) shift to lower frequencies and also, the force by the SW is more dominant. Similarly, the frequency response of the attraction force is calculated when different material is selected: polystyrene (PS), poly(methyl methacrylate) (PMMA) and silica glass (SG)

When the positive direction travelling wave (FIG. 16) is applied, two peak frequencies are observed, but are different from those of the standing wave. While the natural/resonance frequencies of the microbeads do not change with the type of the wave, either being standing or travelling, here it can be seen that attraction force (Bjerknes force between the MP and the NP) depends on the type of the wave. For example, in the case of 7 μm polystyrene bead, the first and second peaks of the attraction force take place at 80 and 132 MHz which is different from their standing wave counterparts. Remarkably, it can be seen even the direction of the travelling wave changes the peak frequencies slightly. Again, for 7 μm, these frequencies are respectively, 84 and 134 MHz. However, the shift is not very significant and normally is within range of 1 or 2 MHz or less particularly for larger sizes. So the peak frequencies of the positive and negative direction travelling waves can be consider the same. Nonetheless, by increasing the size of the MP sphere, the magnitude of the attraction force at these peaks (of the traveling waves) reduces to an extent that second peak of the negative TW disappears for sizes 10 and 15 μm.

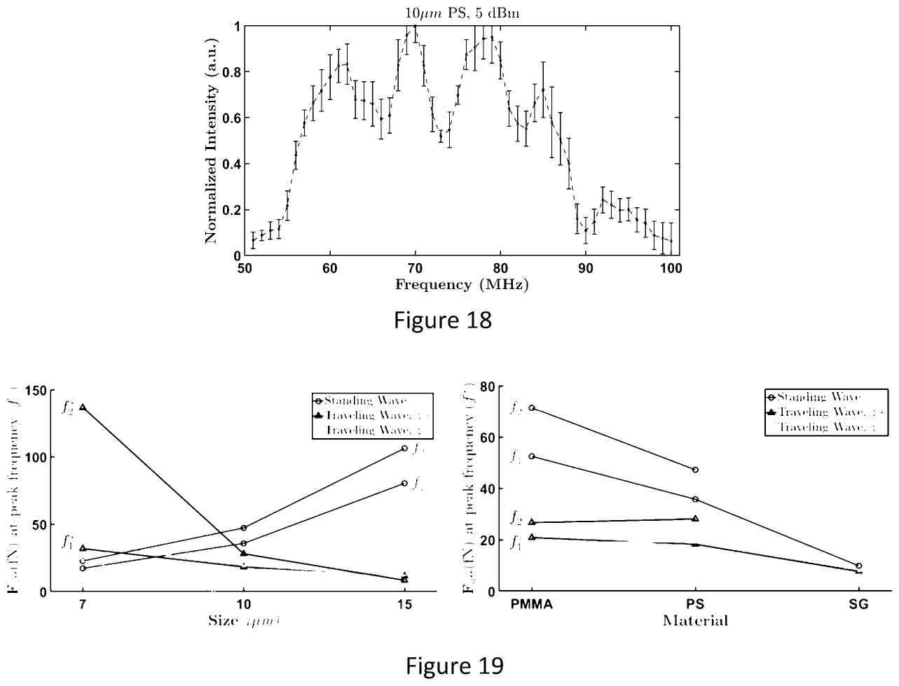

FIG. 18 depicts experimental results of nanoparticle collection using the packed bed of 10-micron polystyrene with a wider range of frequencies (50-100 MHz) which show peaks from Traveling wave (at about 63 and 85 MHz) in addition to previously observed peaks (arisen form standing wave). These experimental results confirm that when the range of excitation frequency is expanded, the other peaks coming from the travelling wave in addition to previously observed peaks. Similar comparison is conducted for different materials (PS, PMMA & SG) of the bead in the packed bed while the size was fixed at 10 micron.

FIG. 19 shows the numerical comparison of the force generated at all peak frequencies for different sizes (a) and different materials (b). Each peak frequency of each wave form is compared with its corresponding order peak frequency of other size or material. In case of size effect, it is predicted by the simulation that in the case of standing wave, if the size is larger, the beads generate higher attraction forces at their corresponding peak frequencies. Nonetheless, in the case of travelling wave, smaller sizes perform better in generating higher attraction forces at peak frequencies. In other words, peaks arisen from travelling wave are more dominant for smaller size beads and standing wave for the larger sizes. In the same way, when different materials are compared, PMMA generates higher attraction particularly in standing wave scenario than PS. Both PMMA and PS outperform SG in terms of higher attraction force. Accordingly, the trend shows when pure standing wave applied larger MPs generate the higher magnitude of attraction force toward the NP but in case of pure travelling wave (in any direction) smaller size at their peak frequency induces a larger force on the NP.

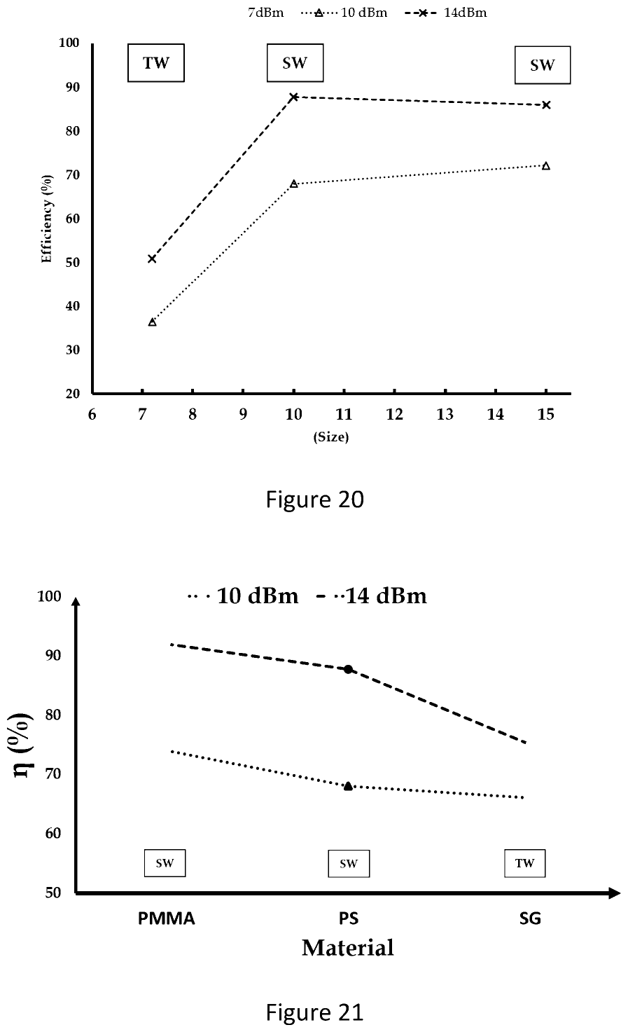

Experimental results (FIG. 20 and FIG. 21) shows agreement with the prediction from the simulation where increasing the size of the bead can provide better capturing, similarly it conforms with prediction that softer polymeric materials can perform better than stiffer materials such as silica glass. In particular, FIG. 20 shows experimental results of comparing the capturing efficiency of different sizes of beads (in the packed bed). The frequency where 7-micron particles show their best efficiency corresponds with the peak arisen form travelling wave (TW). In comparison, 10 and 15-micron particles perform better at peak frequencies that the numerical solution predicted from standing wave (SW). The larger size of the beads performs better that is in agreement with simulation results. FIG. 21 shows a comparison of the performance of different materials PS, PMMA and SG (all with 10 um microbeads) in terms of capturing efficiency. When the best results compared, polymeric materials (PS and PMMA) perform better than SG. The general trend is also in agreement with the simulation where shows that PMMA better than PS (both with their SW dominant peak frequencies) while silica glass' best performance arises from travelling wave (TW). While the collection tends to be most efficient at the resonant peaks predicted by consideration of travelling waves and standing waves, there is considerable collection at frequencies around these resonances, and accordingly, those too are suitable for capture of nanoparticles. For example, as previously mentioned, it may be necessary or desirable to excite the particles at off-resonance frequencies. In some embodiments, the particles may be excited at off-resonance frequencies due to acoustic penetration depth lower/higher frequency (which could be far from resonance). In some embodiments, a mix of different particle sizes may form the packed bed, in which case the applied frequency would be at/near the resonance for some of the particles and off the resonance for other particles.

### Integrity of the Bio-Particles

As the collection of the particles (such as bioparticles) within the flow passage 110 occurs at relatively high frequency ranges, the membrane of the bioparticles needs to remain intact during the ultrasound activation and thus collection stage. To address this, a sample of liposomes with mean particles size of 100 nm with concentration of 1 mg/mL diluted in buffer (10 mM HEPES, 150 mM NaCl, pH 7.2) was passed through a single outlet microfluidic channel (94 μm×21 μm) filled with a packed bed of 10 micron polystyrene particles (Magsphere, USA) where the collection and release cycles were run continuously for 1 hour to ensure that all particles are exposed to the excitation frequency (70 MHz with 13 dBm power level at source signal generator).

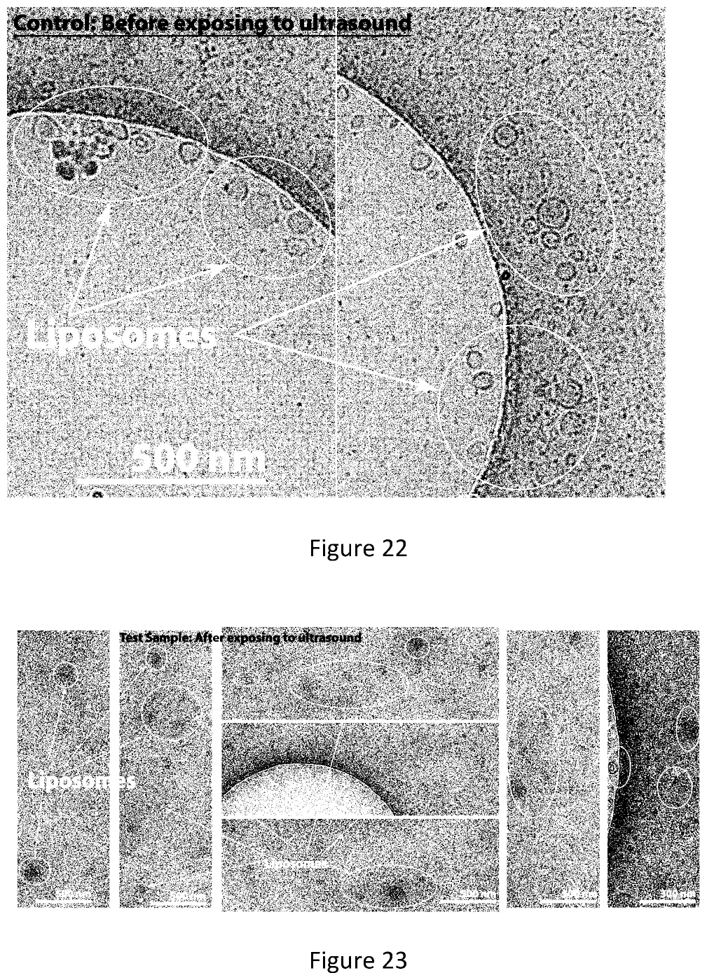

Referring now to FIGS. 22 and 23, there is shown transmission electron microscopy (TEM) images of the control samples (liposomes before exposure to the ultrasound) and test sample (collected after the continuous exposure to ultrasound and passed through the acoustically activated packed bed), respectively. As illustrated, the membranes remain intact and the lipid bilayer is observable from both images. Also most liposome particles retained their spherical shape and morphology, confirming that the mechanical energy transmitted to the liposome while being held in the packed bed does not rupture its membranes nor changes its bilayer lipid structure. As the lipid bilayer is a universal component of all cellular membranes and also makes up the envelope of most viruses, based on this study, it is expected that the morphology and integrity of other particles such as viruses, bacteria and exosomes will also be preserved after exposure to ultrasound. Given the delicate nature of the lipid membrane tested in this study, it is also expected that other membranes (e.g. non lipid membranes) will also remain intact.

### Biological Sample Trapping

In some embodiments, the device 102 is arranged to receive liquid suspension supporting particles, for example one or more bioparticles (i.e. particles of biological origin). The particles may be microparticles, nanoparticles or a combination thereof. In some embodiments, the particles are extracellular vesicles, which include but are not limited to, apoptotic bodies and exosomes. In some embodiments, the particles are viruses and/or bacteria. The viruses and/or particles may be contaminating a sample, which may be any liquid including water, pharmaceutical, or food grade products. More than one type of particle may be supported in the liquid suspension, including a combination of one or more particles described above. Other particles not recited may also be supported in the liquid suspension depending on the specific application.

In some embodiments, the particles supported in the liquid suspension can be microparticles and/or nanoparticles. In some embodiments, the particles have a mean particle size between 1 nm and 10 μm, for example, about 10 nm, 20 nm, 30 nm 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm or 10 μm, although smaller and larger particles are within the scope of this disclosure. The mean particle size may also be provided in a range between any two of these values. In some embodiments, the particle has an mean particle size of between 20 nm and 5 μm, or between 30 nm and 1 μm.

For example, the device 102 may be arranged to receive liquid suspension supporting particles in the range 10 nm to 5000 nm. In some embodiments, the particles are apoptotic bodies and have a mean particle size between 50 nm and 5000 nm. In some embodiments, the particles are microvesicles and have a mean particle size between 100 nm and 1000 nm. In some embodiments, the particles are exosomes and have a mean particle size between 30 nm and 150 nm or between 30 nm and 100 nm. In some embodiments, the particles are viruses and have a mean particle size between 20 nm and 500 nm, or between 20 and 400 nm, for example between 100 and 300 nm. In some embodiments, the particles are bacteria and have a mean particle size between 50 nm and 5000 nm, for example 1000 nm. In some embodiments, the particles are exosomes and have a mean particle size of between 20 nm and 500 nm, or between 50 nm and 300 nm, for example between 100 and 200 nm.

To demonstrate separation and enrichment of biological samples, the inventors conducted an experiment whereby a liquid suspension supporting a sample of exosomes with BCA concentration of 7918 μg/mL and mean particle size 167 nm was passed through an ultrasonically activated packed bed of a separation/filtration/enhancement device.

The packed bed consisted of 15 micron polystyrene particles (Phosphorex, USA) in a channel with 94 μm width and 32 μm height. The exosome sample diluted in phosphate-buffered buffer (PBS) and labelled using ExoGlow protein labelling kit (EXOGP100A-1, Systems Biosciences—USA). The flowrate was set at 0.1 uL/min and fluorescent filter with emission wavelength of 576-596 nm used for visualisation. The interdigital transducers (IDTs) were excited at frequency of 70 MHz and source power level of 14 dBm (Rohde & Schwarz SMC100A signal generator and Amplifier Research 25A250A) for 30 sec.

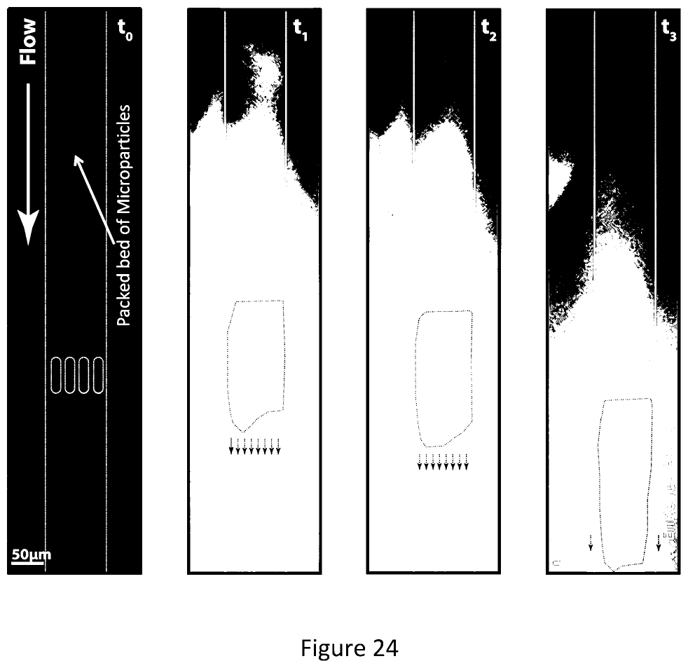

FIG. 24 illustrates four images of the flow passage including the packed bed and post at to (before excitation of surface acoustic wave (SAW)), and then at subsequent times after the SAW turned off (t₁=2 seconds after SAW was OFF, t₂=t₁+0.2 sec and t₃=t₁+3 sec). The images after ultrasound activation (t1 to t3) clearly demonstrates the capturing of fluorescent dyed exosomes and the propagation of the enriched batch into the upstream after release by turning off the ultrasound.

Modifications and variations as deemed obvious to the person skilled in the art are included within the ambit of the present invention as claimed in the appended claims.

1. A microparticle and/or nanoparticle separation, filtration and/or enriching device comprising:
a flow passage through which can be directed a liquid suspension supporting microparticles and/or nanoparticles therein;
at least one packed bed of particles physically retained within the flow passage through which can pass therethrough the liquid suspension; and
an ultrasonic actuation system for mechanically activating the or each packed bed during passage therethrough of the liquid suspension.

2. The microparticle and/or nanoparticle separation, filtration and/or enriching device according to claim 1, wherein the or each packed bed is formed from at least substantially uniformly sized, shaped particles having the same physical properties.

3. The microparticle and/or nanoparticle separation, filtration and/or enriching device according to claim 1 or 2, wherein the particles are generally spherical in shape.

4. The microparticle and/or nanoparticle separation, filtration and/or enriching device according to claim 1 or 2, wherein the particles are generally ellipsoidal, cylindrical, pillar or fibrous in shape.

5. The microparticle and/or nanoparticle separation, filtration and/or enriching device according to any one of the preceding claims, wherein each particle is formed of a polymeric material.

6. The microparticle and/or nanoparticle separation, filtration and/or enriching device according to any one of claims 1 to 4, wherein each particle is formed of a metal, ceramic or crystal material.

7. The microparticle and/or nanoparticle separation, filtration and/or enriching device according to any one of the preceding claims, wherein particles have a dimension measured in micrometres.

8. The microparticle and/or nanoparticle separation, filtration and/or enriching device according to any one of claims 1 to 6, wherein the particles have dimensions measured in millimetres.

9. The microparticle and/or nanoparticle separation, filtration and/or enriching device according to any one of the preceding claims, wherein a plurality of said packed beds are provided, each packed bed being formed from particles of different shapes, dimensions and/or material properties.

10. The microparticle and/or nanoparticle separation, filtration and/or enriching device according to any one of the preceding claims, wherein the or each packed bed is mechanically actuated at or near a resonance frequency of the particles forming the packed bed.

11. The microparticle and/or nanoparticle separation, filtration and/or enriching device according the claim 10, wherein a plurality of said packed beds are provided, each packed bed being mechanically actuated at a different resonance frequency, and or a different power level.

12. The microparticle and/or nanoparticle separation, filtration and/or enriching device according the claim 10 or 11, wherein, in the case of particles having a dimension (d), and the resonance frequency having a wavelength (λ), the first resonance frequency is approximately above d/λ≥0.25 (for spherical particles) and above d/λ≥0.20 (for cylindrical particles).

13. The microparticle and/or nanoparticle separation, filtration and/or enriching device according to claim 10 or 11, wherein, in the case of spherical particles made from PS, the or each packed bed is mechanically actuated at a frequency having a wavelength (λ), and said particles of the or at least one of said packed beds have a diameter (d) in the range of around less than 0.3λ to 0.67λ.

14. The microparticle and/or nanoparticle separation, filtration and/or enriching device according to claim 13, wherein the or each said packed bed is mechanically actuated at a frequency having a wavelength (λ), and said particles of the or at least one said packed bed have a diameter (d) of less than around 0.3λ.

15. The microparticle and/or nanoparticle separation, filtration and/or enriching device according to claim 13, wherein the or each packed bed is mechanically actuated at a frequency having a wavelength (λ), and said particles of the or at least one said packed bed have a diameter (d) in the range of around 0.3λ to 0.45λ.

16. The microparticle and/or nanoparticle separation, filtration and/or enriching device according to claim 13, wherein the or each packed bed is mechanically actuated at a frequency having a wavelength (λ), and said particles of the or at least one said packed bed have a diameter (d) in the range of around 0.45λ to 0.67λ.

17. The microparticle and/or nanoparticle separation, filtration and/or enriching device according to claim 10 or 11, wherein, in the case of spherical particles made from PMMA, the or each packed bed is mechanically actuated at a frequency having a wavelength (λ), and said particles of the or at least one of said packed beds have a diameter (d) in the range of around less than 0.32λ to 0.6λ.

18. The microparticle and/or nanoparticle separation, filtration and/or enriching device according to claim 17, wherein the or each said packed bed is mechanically actuated at a frequency having a wavelength (λ), and said particles of the or at least one said packed bed have a diameter (d) of less than around 0.32λ.

19. The microparticle and/or nanoparticle separation, filtration and/or enriching device according to claim 17, wherein the or each packed bed is mechanically actuated at a frequency having a wavelength (λ), and said particles of the or at least one said packed bed have a diameter (d) in the range of around 0.32λ to 0.415λ.

20. The microparticle and/or nanoparticle separation, filtration and/or enriching device according to claim 17, wherein the or each packed bed is mechanically actuated at a frequency having a wavelength (λ), and said particles of the or at least one said packed bed have a diameter (d) in the range of around 0.415λ to 0.6λ.

21. The microparticle and/or nanoparticle separation, filtration and/or enriching device according to any one of the preceding claims, further comprising a packed bed retaining system for retaining the packed bed in position within the flow passage, while allowing the passage of microparticle and/or nanoparticles therethrough.

22. The microparticle and/or nanoparticle separation, filtration and/or enriching device according to claim 21, wherein the flow passage is a microfluidic channel.

23. The microparticle and/or nanoparticle separation, filtration and/or enriching device according to claim 22, wherein the bed retaining system comprises one or more micropillar posts extending along the flow passage downstream of the packed bed.

24. The microparticle and/or nanoparticle separation, filtration and/or enriching device according to any one of the preceding claims, wherein the ultrasonic actuation device is a piezoelectric device.

25. The microparticle and/or nanoparticle separation, filtration and/or enriching device according to claim 24, wherein the piezoelectric device is a surface acoustic wave (SAW) actuator.

25. A method of separating, filtering and/or enriching microparticles and/or nanoparticles from a liquid suspension comprising:
directing the liquid suspension through a flow passage within which is provided one or more packed beds of physically retained particles through which passes the liquid suspension; and
mechanically activating the or each bed while the liquid suspension passes through to thereby capture microparticles and/or nanoparticles within the or each packed bed.

26. The method according to claim 25, wherein the or each packed bed is formed from at least substantially uniformly sized, shaped particles having the same physical properties.

27. The method according to claim 25 or 26, wherein the particles are generally spherical in shape.

28. The method according to claim 25 or 26, wherein the particles are generally ellipsoidal, cylindrical, pillar or fibrous in shape.

29. The method according to any one of claims 25 to 28, wherein each particle is formed of a polymeric material.

30. The method according to any one of claims 25 to 28, wherein each particle is formed of a metal, ceramic or crystal material.

31. The method according to any one of claims 25 to 30, wherein particles have a dimension measured in micrometres.

32. The method according to any one of claims 25 to 30, wherein the particles have dimensions measured in millimetres.

33. The method according to any one of claims 25 to 32, wherein a plurality of said packed beds are provided, each packed bed being formed from particles of different shapes, dimensions and/or material properties.

34. The method according to any one of claims 25 to 33, comprising mechanically actuating the or each packed bed at or near a resonance frequency of the particles forming the or each said packed bed.

35. The method according the claim 34, comprising mechanically actuating a plurality of said packed beds, each packed bed being mechanically actuated at a different resonance frequency, and/or a different power level.

36. The method according to claim 34 or 35, wherein, in the case of particles having a dimension (d), and the resonance frequency having a wavelength (l), the first resonance frequency is approximately above d/λ≥0.25 (for spherical particles) and above d/λ≥0.20 (for cylindrical particles).

37. The method according to claim 36, comprising mechanically actuating the or said packed bed at a frequency having a wavelength (λ), said particles of the or at least one of said packed beds having a diameter (d) in the range of around less than 0.3λ to 0.67λ.

38. The method according to claim 36, comprising mechanically actuating the or each said packed bed at a frequency having a wavelength (λ), said particles of the or at least one said packed bed having a diameter (d) of less than around 0.3λ.

39. The method according to claim 36, comprising mechanically actuating the or each packed bed at a frequency having a wavelength (λ), said particles of the or at least one said packed bed having a diameter (d) in the range of around 0.3λ to 0.45λ.

40. The method according to claim 36, comprising mechanically actuating the or each said packed bed at a frequency having a wavelength (λ), said particles having a diameter (d) in the range of around 0.45λ to 0.67λ.

41. The method according to claim 34 or 35, wherein, in the case of spherical particles made from PMMA, the or each packed bed is mechanically actuated at a frequency having a wavelength (λ), and said particles of the or at least one of said packed beds have a diameter (d) in the range of around less than 0.32λ to 0.6λ.

42. The method according to claim 41, wherein the or each said packed bed is mechanically actuated at a frequency having a wavelength (λ), and said particles of the or at least one said packed bed have a diameter (d) of less than around 0.32λ.

43. The method according to claim 41, wherein the or each packed bed is mechanically actuated at a frequency having a wavelength (λ), and said particles of the or at least one said packed bed have a diameter (d) in the range of around 0.32λ to 0.415λ.

44. The method according to claim 41, wherein the or each packed bed is mechanically actuated at a frequency having a wavelength (λ), and said particles of the or at least one said packed bed have a diameter (d) in the range of around 0.415λ to 0.6λ.

45. The method according to any one of claims 25 to 44, comprising intermittently suspending the mechanical activation of the or each packed bed to thereby release the captured microparticles and/or nanoparticles therefrom.

46. The method according to any one of claims 25 to 45, comprising delivering batch volume of the liquid suspension through the flow passage.

47. The method according to any one of claims 25 to 45, comprising delivering a continuous stream of the liquid suspension through the passage.

48. The method according to any one of claims 25 to 47, wherein the nanoparticles are extracellular vesicles.

49. The method according to claim 48, wherein the extracellular vesicles include apoptotic bodies and exosomes.

50. The method according to any one of claims 25 to 47, wherein the liquid suspension is a contaminated water, and the nanoparticles are contaminants within the water.

51. The method according to claim 50 wherein the contaminants include viruses and/or bacteria.

52. The method according to any one of claims 25 to 47, wherein the nanoparticles are precious metal or non-metal nanoparticles

53. The method according to any one of claims 25 to 47, wherein the nanoparticles are DNA.

54. A system for separating, filtering and/or enriching microparticles and/or nanoparticles from a liquid suspension, the system comprising:
one or more processors;
memory comprising computer executable code, which when executed by the one or more processors, is configured to perform a filtration process and a subsequent collection process,
wherein during the filtration process, the one or more processors are configured to:
activate a first switch, wherein the first switch is configured to control fluid flow along a first conduit, the first conduit arranged to provide fluid communication between an outlet of a microparticle and/or nanoparticle separation, filtration and/or enriching device and a first receptacle, and whereby activating the first switch allows fluid flow between the outlet and the first receptacle; and
trigger an ultrasound signal to cause an ultrasonic transducer of the device to generate a sound wave to activate a packed bed of particles of the device, to thereby cause microparticles and/or nanoparticles of a liquid suspension to be trapped and collected inside the device and for filtered liquid to be conveyed along the first conduit to the receptacle; and
wherein during the collection process, the one or more processors are configured to:
turn off the ultrasound signal to stop activation of the packed bed of particles of the device; and
deactivate the first switch to impede fluid flow between the outlet and the first receptacle; and
activate a second switch, wherein the second switch is configured to control fluid flow along a second conduit, the second conduit arranged to provide fluid communication between the outlet of the device and a second receptacle, and whereby activating the second switch allows fluid flow between the outlet and the second receptacle.

55. The system of claim 54, wherein at the end of a collection process, the one or more processors are configured to execute computer code to cause the system to perform a subsequent filtration process and a subsequent collection process.

56. The system of claim 54 or 55, wherein the microparticle and/or nanoparticle separation, filtration and/or enriching device comprises the microparticle and/or nanoparticle separation, filtration and/or enriching device of any one of claims 1 to 24.

57. A method for separating, filtering and/or enriching microparticles and/or nanoparticles from a liquid suspension, the method comprising:
a filtration process and a subsequent collection process,
wherein the filtration process comprises:
activating a first switch, wherein the first switch is configured to control fluid flow along a first conduit, the first conduit arranged to provide fluid communication between an outlet of a microparticle and/or nanoparticle separation, filtration and/or enriching device and a first receptacle, and whereby activating the first switch allows fluid flow between the outlet and the first receptacle; and
triggering an ultrasound signal to cause an ultrasonic transducer of the device to generate a sound wave to activate a packed bed of particles of the device, to thereby cause microparticles and/or nanoparticles of a liquid suspension to be trapped and collected inside the device and for filtered liquid to be conveyed along the first conduit to the receptacle; and
wherein the collection process comprises:
turning off the ultrasound signal to stop activation of the packed bed of particles of the device; and
deactivating the first switch to impede fluid flow between the outlet and the first receptacle; and
activating a second switch, wherein the second switch is configured to control fluid flow along a second conduit, the second conduit arranged to provide fluid communication between the outlet of the device and a second receptacle, and whereby activating the second switch allows fluid flow between the outlet and the second receptacle.

58. The system of claim 57, wherein the method comprises performing a subsequent cycle of a filtration process and a subsequent collection process.

59. A non-transitory machine-readable medium storing instructions which, when executed by one or more processors, cause a system to implement a method according to claim 57 or claim 58.
